(19) United States
(12) Patent Application Publication
(10) Pub. No.: US 2014/0024023 A1
(43) Pub. Date: Jan. 23, 2014

(54) DROPLET GENERATION SYSTEM WITH FEATURES FOR SAMPLE POSITIONING

(71) Applicant: Bio-Rad Laboratories, Inc, Hercules, CA (US)

(72) Inventors: Thomas H. Cauley, III, Pleasanton, CA (US); Timothy Brackbill, Oakland, CA (US); Luc Bousse, Los Altos, CA (US); Jon Petersen, Redwood City, CA (US)

(73) Assignee: Bio- Rad Laboratories, Inc, Hercules, CA (US)

(21) Appl. No.: 13/949,115

(22) Filed: Jul. 23, 2013

Related U.S. Application Data
(60) Provisional application No. 61/674,516, filed on Jul. 23, 2012.
(60) Provisional application No. 61/759,775, filed on Feb. 1, 2013.

(51) Int. Cl. G01N 1/28

(52) U.S. Cl. CPC G01N 1/28
USPC 435/6.1; 436/174

(57) ABSTRACT

System, including methods and apparatus, for forming droplets of an emulsion. The system may include a channel junction at which a stream of sample fluid is divided into droplets by a dividing flow of carrier fluid. The system also may include one or more features configured to position sample fluid for reduced contact between the sample fluid and one or more surface regions of the channel junction, which may improve the consistency of droplet formation. In exemplary embodiments, sample fluid may be positioned by a step member produced by an increase in channel depth, and/or by directing flow of carrier fluid to form a barrier layer between sample fluid and a wall region, such as a ceiling region or floor region, of a channel network.

### CROSS-REFERENCES TO PRIORITY APPLICATIONS

This application is based upon and claims the benefit under 35 U.S.C. §119(e) of U.S. Provisional Patent Application Ser. No. 61/674,516, filed Jul. 23, 2012, and U.S. Provisional Patent Application Ser. No. 61/759,775, filed Feb. 1, 2013, each of which is incorporated herein by reference in its entirety for all purposes.

### CROSS-REFERENCES TO OTHER MATERIALS

This application incorporates by reference in their entireties for all purposes the following patent documents: U.S. Pat. No. 7,041,481, issued May 9, 2006; U.S. Patent Application Publication No. 2010/0173394 A1, published Jul. 8, 2010; U.S. Patent Application Publication No. 2011/0217712 A1, published Sep. 8, 2011; U.S. Patent Application Publication No. 2012/0152369 A1, published Jun. 21 2012; U.S. Patent Application Publication No. 2012/0190032 A1, published Jul. 26, 2012; U.S. Provisional Patent Application Ser. No. 61/813,137, filed Apr. 17, 2013; and U.S. Provisional Patent Application Serial No. 61/838,063, filed Jun. 21, 2013.

### INTRODUCTION

Emulsions hold substantial promise for revolutionizing how fluid is manipulated and processed. Emulsification techniques can create large numbers of droplets that can function as independent reaction chambers (“microreactors”) for chemical reactions. For example, droplets can be utilized for clinical assays, biomedical research, producing biological compounds, nanoparticle synthesis, other manufacturing processes, and the like.

Aqueous droplets can be utilized to perform assays. The droplets can be suspended in oil to create a water-in-oil (W/O) emulsion. The emulsion can be stabilized with a surfactant to reduce coalescence of droplets during heating, cooling, and transport, thereby enabling thermal processing, such as thermal cycling, to be performed. Accordingly, emulsions have been utilized to achieve single-copy amplification of nucleic acid target molecules in droplets with the polymerase chain reaction (PCR). Detection of the presence of individual molecules of a target in droplets enables performance of digital assays.

Digital assays generally benefit from droplets having a uniform size (i.e., monodisperse droplets). With this constraint, the assays can exhibit higher accuracy because each droplet can be assumed to be a microreactor of the same volume, which simplifies data processing. If droplet size cannot be controlled tightly, the resulting droplet polydispersity can increase an assay's sensitivity to false positives. For example, larger negative droplets may be mischaracterized as positive because their increased size produces a higher background signal.

Synthesis of materials of interest also can be conducted advantageously in droplets. For example, particle synthesis and biological synthesis can benefit from a uniform droplet size because the uniform size can control the thermal and diffusive characteristics of reactions within the confines of each droplet.

Monodisperse droplets can be produced serially from a droplet generator. However, the performance of droplet generators can be sensitive to various parameters such as flow rate, sample composition, carrier composition, type and amount of surfactant, and the like. Improved droplet generators are needed to create droplets of emulsions, such as for droplet-based assays, particle synthesis, production of compounds of interest, fluid processing, and the like.

### SUMMARY

The present disclosure provides a system, including methods and apparatus, for forming droplets of an emulsion. The system may include a channel junction at which a stream of sample fluid is divided into droplets by a dividing flow of carrier fluid. The system also may include one or more features configured to position sample fluid for reduced contact between the sample fluid and one or more surface regions of the channel junction, which may improve the consistency of droplet formation. In exemplary embodiments, sample fluid may be positioned by a step member produced by an increase in channel depth, and/or by directing flow of carrier fluid to form a barrier layer between sample fluid and a wall region, such as a ceiling region or floor region, of a channel network.

### BRIEF DESCRIPTION OF THE DRAWINGS

FIG. 1A is a schematic view of an exemplary system for droplet generation with sample position affected by a step disposed at or upstream of a channel junction, in accordance with aspects of the present disclosure.

FIG. 1B is a schematic view of an exemplary system for droplet generation with sample position affected by a barrier layer of carrier fluid introduced by an auxiliary channel upstream of a channel junction at which droplets are formed, in accordance with aspects of the present disclosure.

FIG. 1C is a schematic view of an exemplary system for droplet generation with sample position affected by a barrier layer of carrier fluid produced by directing carrier fluid with at least one flow-modifying structure projecting into at least one carrier input channel, in accordance with aspects of the present disclosure.

FIG. 2 is a fragmentary sectional view of an exemplary device for droplet generation in which sample position is not affected by a step or a barrier layer, in accordance with aspects of the present disclosure.

FIG. 3 is a fragmentary sectional view of the device of FIG. 2, taken generally along line 3-3 of FIG. 2.

FIG. 4 is a line drawing of an exemplary image collected at a droplet generating portion of a physical model of the device of FIG. 2, with the image representing an early time point in a droplet production run, before a sample wetting line has been established to stabilize droplet size, in accordance with aspects of the present disclosure.

FIG. 5 is a line drawing of another exemplary image collected as in FIG. 4, but later in the same droplet production run, after a sample wetting line has been established to stabilize droplet size, in accordance with aspects of the present disclosure.

FIG. 6 is a graph of measured droplet size plotted according to droplet position number within a droplet production run performed using the physical model of FIG. 4, in accordance with aspects of the present disclosure.

FIG. 7 is a graph of data collected generally as in FIG. 6 but for multiple droplet production runs testing different sample and carrier compositions, in accordance with aspects of the present disclosure.

FIG. 8 is a schematic view taken generally around a droplet generating portion of the device of FIG. 2, illustrating a failure to generate droplets from a viscoelastic sample, in accordance with aspects of the present disclosure.

FIG. 9 is a fragmentary, generally top view of a base of an exemplary droplet generation device configured to create a sample wetting boundary with a step produced by an abrupt increase in channel height/depth, with a cap of the device removed to simplify the presentation, in accordance with aspects of the present disclosure.

FIG. 10 is a fragmentary sectional view of the device of FIG. 9, taken generally along line 10-10 of FIG. 9.

FIG. 11 is a fragmentary sectional view of the device of FIG. 9, taken generally along line 11-11 of FIG. 10 in the presence of the cap of the device.

FIG. 12 is a fragmentary sectional view of the device of FIG. 9, taken generally at the region indicated at “12” in FIG. 11 in the presence of sample and carrier fluid and illustrating how a wetting boundary may control sample position, in accordance with aspects of the present disclosure.

FIG. 13 is a fragmentary sectional view of an exemplary droplet generation device, taken generally as in FIG. 10, but having a T-shaped arrangement of channels with a single input channel for carrier fluid and configured to create a sample wetting boundary at step created by an abrupt increase in channel height, in accordance with aspects of the present disclosure.

FIG. 14 is a fragmentary, generally top view of a base of another exemplary droplet generation device, taken as in FIG. 9, with the device configured to create a sample wetting boundary at a curved step, in accordance with aspects of the present disclosure.

FIG. 15 is a fragmentary sectional view of the device of FIG. 14, taken generally along line 15-15 of FIG. 14.

FIG. 16 is a fragmentary sectional view of yet another exemplary droplet generation device, taken generally as in FIG. 10 but having a step that is flush with an adjacent lateral side wall region of both carrier input channels, in accordance with aspects of the present disclosure.

FIG. 17 is a fragmentary top view of still another exemplary droplet generation device configured to create a wetting boundary through the presence of a series of elongate surface features defined by the cap of the device, in accordance with aspects of the present disclosure.

FIG. 18 is a fragmentary sectional view of the device of FIG. 17, taken generally along line 18-18 of FIG. 17.

FIG. 19 is a fragmentary sectional view of the device of FIG. 17, taken generally at the region indicated at “19” in FIG. 18 to magnify the surface features.

FIG. 20 is a fragmentary sectional view taken as in FIG. 19 and showing another embodiment having grooves as surface features that are more widely spaced, in accordance with aspects of the present disclosure.

FIG. 21 is a fragmentary sectional view taken as in FIG. 19 of an embodiment having projecting ridges as surface features to create a wetting boundary, in accordance with aspects of the present disclosure.

FIG. 22 is a fragmentary sectional view taken as in FIG. 19 of an embodiment having rectangular grooves as surface features to create a wetting boundary, in accordance with aspects of the present disclosure.

FIG. 23 is a fragmentary sectional view taken as in FIG. 19 of an embodiment having projecting rectangular ridges as surface features to create a wetting boundary, in accordance with aspects of the present disclosure.

FIG. 24 is a simplified, fragmentary sectional view of the droplet generation device of FIG. 21, taken in the presence of sample and carrier fluid and illustrating how one of the triangular ridges may establish a wetting boundary that controls sample position, in accordance with aspects of the present disclosure.

FIG. 25 is a simplified, fragmentary sectional view of the droplet generation device of FIG. 22, taken in the presence of sample and carrier fluid and illustrating how one of the rectangular grooves may establish a wetting boundary that controls sample position, in accordance with aspects of the present disclosure.

FIG. 26 is a simplified, fragmentary sectional view of the droplet generation device of FIG. 23, taken in the presence of sample and carrier fluid and illustrating how one of the rectangular ridges may establish a wetting boundary that controls sample position, in accordance with aspects of the present disclosure.

FIG. 27 is a fragmentary top view of an exemplary droplet generation device configured to create a wetting boundary through the presence of a series of curved, elongate surface features defined by the cap of the device, in accordance with aspects of the present disclosure.

FIG. 28 is a graph of data collected with working models of the droplet generation device of FIG. 2 (“no step”) and FIG. 16 (“20 μm step” or “40 μm step”), with droplet size plotted as a function of droplet position number within a droplet production run for each size of step, in accordance with aspects of the present disclosure.

FIG. 29 is a fragmentary sectional view of an exemplary droplet generation device configured to create a sample wetting boundary through the presence of an abrupt edge defined by a lateral side wall region of a sample input channel, in accordance with aspects of the present disclosure.

FIG. 30 is a fragmentary sectional view of an exemplary droplet generation device configured to create a sample wetting boundary through the presence of a series of projections defined by a lateral side wall region of a sample input channel, in accordance with aspects of the present disclosure.

FIG. 31 is a fragmentary sectional view of an exemplary droplet generation device configured to create a sample wetting boundary through the presence of a step extending a majority of the distance across a channel junction toward an output channel, in accordance with aspects of the present disclosure.

FIG. 32 is a fragmentary sectional view of an exemplary droplet generation device configured to create a sample wetting boundary through the presence of a series of arcuate steps defined by the base of the device, in accordance with aspects of the present disclosure.

FIG. 33 is a fragmentary sectional view of the droplet generation device of FIG. 32, taken generally along line 33-33 of FIG. 32.

FIG. 34 is a schematic top view of a droplet generating portion of an exemplary droplet generation device having a “double cross” design configured to create a barrier layer of carrier fluid to mitigate transient effects during droplet generation.

FIG. 35 is a fragmentary plan view of a central portion of a base of an embodiment of the droplet generation device of FIG. 34, taken in the absence a cap that attaches to the base, in accordance with aspects of the present disclosure.

FIG. 36 is a magnified perspective view of a droplet generating portion of the base of FIG. 35.

FIG. 37 is a sectional view of the droplet generation device of FIG. 35, taken generally along line 37-37 of FIG. 36.

FIG. 38 is a fragmentary schematic sectional view of an exemplary device for producing droplets, including two separate auxiliary carrier input channels configured to create barrier layers along opposite surface regions (e.g., floor and ceiling regions) of a sample input channel, in accordance with aspects of the present disclosure.

FIG. 39 is a flowchart depicting exemplary steps of a method for producing droplets according to aspects of the present disclosure.

FIG. 40 is a fragmentary isometric view of a base of an exemplary droplet generation device, taken generally around a droplet generating portion of the device in the absence of a cap that overlies the base, and including a pair of flow-modifying structures projecting into carrier input channels on opposite lateral sides of a sample flow path and configured to direct flow of carrier fluid over a portion of a sample stream in the flow path, in accordance with aspects of the present disclosure.

FIG. 41 is a fragmentary top view of the base of the droplet generation device of FIG. 40, taken generally around the same region as FIG. 40.

FIG. 42 is a sectional view of the device of FIG. 40, taken generally along line 42-42 of FIG. 41 in the presence of the cap, sample fluid, and carrier fluid.

FIG. 43 is a sectional view of the device of FIG. 40, taken generally along line 43-43 of FIG. 41 in the presence of the cap.

FIG. 44 is a fragmentary isometric view of a base of another exemplary droplet generation device having flow-modifying structures projecting into carrier input channels, taken generally around a droplet generating portion of the device in the absence of a cap that overlies the base, in accordance with aspects of the present disclosure.

FIG. 45 is a fragmentary isometric view of a base of an exemplary droplet generation device having flow-modifying structures formed as islands projecting into carrier input channels, taken generally around a droplet generating portion of the device in the absence of a cap that overlies the base, in accordance with aspects of the present disclosure.

FIG. 46 is a fragmentary top view of the base of the droplet generation device of FIG. 45, taken generally around the same region as FIG. 45.

FIG. 47 is a sectional view of the device of FIG. 45, taken generally along line 47-47 of FIG. 46 in the presence of the cap.

FIG. 48 is a sectional view of the device of FIG. 45, taken generally along line 48-48 of FIG. 46 in the presence of the cap.

### DETAILED DESCRIPTION

The present disclosure provides a system, including methods and apparatus, for forming droplets of an emulsion. The system may include a channel junction at which a stream of sample fluid is divided into droplets by a dividing flow of carrier fluid. The system also may include one or more features configured to position sample fluid for reduced contact between the sample fluid and one or more surface regions of the channel junction, which may improve the consistency of droplet formation. In exemplary embodiments, sample fluid may be positioned by a step member produced by an increase in channel depth, and/or by directing flow of carrier fluid to form a barrier layer between sample fluid and a wall region, such as a ceiling region or floor region, of a channel network.

An exemplary method of forming droplets of an emulsion is provided. In the method, a sample stream may be created. Portions of the sample stream may be divided into droplets disposed in carrier fluid after each portion exits a sample input channel. Carrier fluid may be directed into contact with the portions of the sample stream at a position upstream from where the portions exit the sample input channel. Portions of the sample stream may be divided with carrier fluid, and carrier fluid may be directed into contact with the portions of the sample stream, with carrier fluid supplied by the same one or more carrier input channels or with different carrier input channels. For example, the sample stream may be divided at a first channel junction and carrier fluid may be directed into contact with the portions of the sample stream at a distinct second channel junction.

Another exemplary method of forming droplets of an emulsion is provided. In the method, a sample stream may be created, with the sample stream having a first side and a second side opposite and spaced from each other in a direction transverse to a plane defined by a channel network containing the sample stream. The sample stream may be divided into droplets with a first portion of carrier fluid. A second portion of the carrier fluid may be directed selectively to the first side relative to the second side of the sample stream at a position upstream from where the sample stream is divided into droplets. The first portion may form a dividing flow of carrier fluid, and the second portion may form a barrier flow (e.g., a lubricating flow) of carrier fluid.

Yet another exemplary method of forming an emulsion is provided. In the method, a sample stream may be created, with the sample stream flowing in a circumferentially bounded portion of a sample input channel along a flow axis and out an end defined by the bounded portion near or at a channel junction of a channel network including the sample input channel and defining a plane. An edge region of a step member may be contacted with the sample stream. The edge region may be offset from the end of the bounded portion in a direction parallel to the flow axis. The step member may be formed by an increase in depth of a region of the channel network with the depth increasing in a downstream direction. The sample stream may be divided into droplets with carrier fluid flowing in one or more second channels to the channel junction.

The term “wetting boundary,” as used in the present disclosure, means any boundary between sample fluid and a wall of a channel network within which the sample fluid is transported. For example, a wetting boundary may include a layer of some other fluid, such as a carrier fluid or a dilution fluid, which separates sample fluid from a wall of the channel network. Such a layer may be referred to herein interchangeably as a “barrier layer,” a “boundary layer,” or a “lubrication layer.” Wetting boundaries as described herein may be formed in a variety of ways, which may involve one or more geometrical features, such as a step, configured to result in a degree of separation between a sample fluid and a channel network wall, and/or which may involve one or more auxiliary fluid channels and/or one or more flow-modifying structures configured to interpose another fluid between the sample fluid and a channel network wall.

A device for producing droplets is provided. The device may comprise a channel network including a sample input channel and a first carrier input channel each extending to a first channel junction in a droplet generation region. An output channel may extend from the first channel junction. A step member disposed at or upstream from the first channel junction may be configured to produce a sample wetting boundary at a position along a surface of the channel network. Alternatively, or in addition, a second carrier input channel may extend to a second channel junction intersecting the sample input channel, upstream from the first channel junction. The device may be configured so that carrier fluid introduced through the second, upstream carrier input channel will form a barrier layer between sample fluid in the sample input channel and one or more walls of the sample input channel, in a region extending between the second channel junction and the first channel junction.

Another device for producing droplets is provided. The device may comprise a channel network including a sample input channel and a first carrier input channel each extending to a first channel junction in a droplet generation region. An output channel may extend from the channel junction. Second and third carrier input channels may intersect the sample input channel upstream from the first channel junction. The device may be configured so that carrier fluid introduced through the second and third carrier input channels will form barrier layers between sample fluid in the sample input channel and two walls of the sample input channel, in a region extending between the second channel junction and the first channel junction. For example, barrier layers may be formed between the sample fluid and top and bottom walls of the sample input channel.

Yet another device for producing droplets is provided. The device may comprise a channel network including a sample input channel and a first carrier input channel each extending to a first channel junction in a droplet generation region. An output channel may extend from the channel junction. A second carrier input channel may extend to a second channel junction intersecting the sample input channel, upstream from the first channel junction. The channel network may define a plane and have a floor and a ceiling spaced from each other in a direction transverse to the plane. The device may be configured so that carrier fluid introduced through the second carrier input channel will form a first barrier layer between sample fluid in the sample input channel and either the floor or the ceiling of the channel network, in a region extending between the second channel junction and the first channel junction.

In addition, the channel network may include another feature configured to form a wetting boundary between sample fluid in the sample input channel and either the floor or the ceiling of the channel network, in a region extending between the second channel junction and the first channel junction, or at the channel junction. Various types of features of this nature may be provided. For example, an elevation of the floor may decrease abruptly or an elevation of the ceiling may increase abruptly, at the first channel junction, or upstream of the first channel junction in the sample input channel. In some embodiments, a width of the channel network may increase abruptly, at the first channel junction or upstream thereof in the sample input channel. In some embodiments, an edge may be formed that is oriented transverse to the sample input channel and substantially parallel or orthogonal to the plane defined by the channel network. The edge may be formed by a convex corner at the channel junction, upstream of the first channel junction in the sample input channel, or both. In some embodiments, the channel network may include a step, a notch, a ridge, a groove, or a combination thereof, among others, defined by a ceiling and/or a floor and/or a lateral side wall of the device.

In some embodiments, the channel network may define a plurality of such wetting boundary producing features arranged along the sample input channel and/or the first channel junction (e.g., arranged along a line extending from the sample input channel to the output channel). In some embodiments, the channel network may define a plurality of features configured to produce wetting boundaries along different walls of the channel network, either at the same position along a channel/channel junction or at different positions. The wetting boundaries may be continuous with one another or separate.

A method of producing droplets is provided. The method may be performed with any of the devices disclosed herein configured to produce a wetting boundary, such as a barrier layer of carrier fluid, either with a geometric feature, such as a step or a flow-modifying feature, or with a dedicated auxiliary fluid channel. In the method, a sample and carrier fluid may be caused to flow (e.g., driven) along a sample input channel and into first and second carrier input channels, respectively. Droplets including the sample and disposed in the carrier fluid may be formed in a droplet generation region in the vicinity of a first channel junction defined by the intersection of the sample input channel with the first carrier input channel. The droplets in carrier fluid may be caused to flow (e.g., driven) in the output channel away from the channel junction.

In addition, a second channel junction, upstream from the first channel junction, may be defined by the intersection of the sample input channel with the second carrier input channel. The second channel junction may be disposed in an upstream position such that a wetting boundary in the form of a barrier layer of carrier fluid is formed between at least one surface region of the sample input channel and the sample fluid in a region of the sample input channel extending between the second channel junction and the first channel junction. In some cases, a wetting boundary also may be formed in the droplet generation region by a geometric feature, for example, a step forming a convex corner. The combination of a wetting boundary produced by an auxiliary fluid channel along one side of a channel network, and a wetting boundary produced by a geometric feature along another side of the channel network, may be used to reduce or eliminate transient effects such as effects due to transient surfactant build-up in the channel network during droplet generation.

More specifically, the system of the present disclosure may provide more consistent and/or robust droplet generation. The system may produce less variability in droplet size, such as by reducing the occurrence of droplet size transients, particularly near the beginning of a droplet generation run. Also, the system may increase the tolerance of droplet generation to increased viscoelasticity of the dispersed phase. For example, the system may permit an aqueous phase containing a polymer, such as high molecular weight nucleic acid, to be utilized as the dispersed phase, optionally at a higher frequency of droplet generation.

The present disclosure provides a device having a carrier fluid input channel in the sample channel upstream from the droplet generation region and/or a surface discontinuity in the sample channel at and/or just before the droplet generation region. The upstream carrier fluid input channel is configured to provide a wetting boundary in the form of a carrier fluid barrier layer that extends toward, if not all the way to, the droplet generation region. The surface discontinuity is configured to produce a linear, bent, and/or curved wetting line for the sample fluid. The discontinuity can pin the sample fluid wetting line to a fixed location, which returns droplet generation to a more geometry-mediated regime. The presence of a carrier fluid barrier layer and/or a predefined sample wetting line can mitigate the magnitude of initial transients.

The carrier fluid wetting boundary may be produced along a portion of a wall of the channel network in a region extending toward the droplet generation region, along the entirety of a wall, or along portions or the entirety of more than one wall. The surface discontinuity may be a step, a recess, and/or a projection positioned at or upstream of a droplet generation intersection, to stabilize droplet size. The present disclosure takes advantage of the realization that droplet generation depends on surface wetting phenomena. Therefore, the droplet generators disclosed herein incorporate barrier layers and/or geometric features to affect surface wetting.

The system of the present disclosure may reduce (and/or eliminate) the initial transient of size variability exhibited by a droplet generator. As a result, the droplet generator can produce a more monodisperse emulsion of sample droplets. Also, the system may be less sensitive to the viscoelasticity or composition of the input sample. For example, this decreased sensitivity may be useful for samples containing nucleic acid, which can affect droplet size. The nucleic acid can cause the sample to wet the channel junction and drift downstream into the outlet channel where the sample stream can spontaneously break into droplets, without boundary layers or control by the geometry of the channel junction. Also, the nucleic acid, which may be digested or undigested, may be prepared using various sample preparation techniques by various users, which may cause nucleic acid-containing samples to also contain components that can shift droplet sizes in traditional droplet generators lacking the features disclosed herein. By creating carrier fluid boundary layers and/or pinning sample wetting to the channel junction (or immediately upstream thereof), the droplet generator can be less sensitive to sample viscoelasticity and composition.

Further aspects of the present disclosure are presented in the following sections: (I) droplet generation system with an edge forming a sample wetting boundary, (II) droplet generation system with a barrier layer of carrier fluid, and (III) examples.

### I. DROPLET GENERATION SYSTEM WITH AN EDGE FORMING A SAMPLE WETTING BOUNDARY

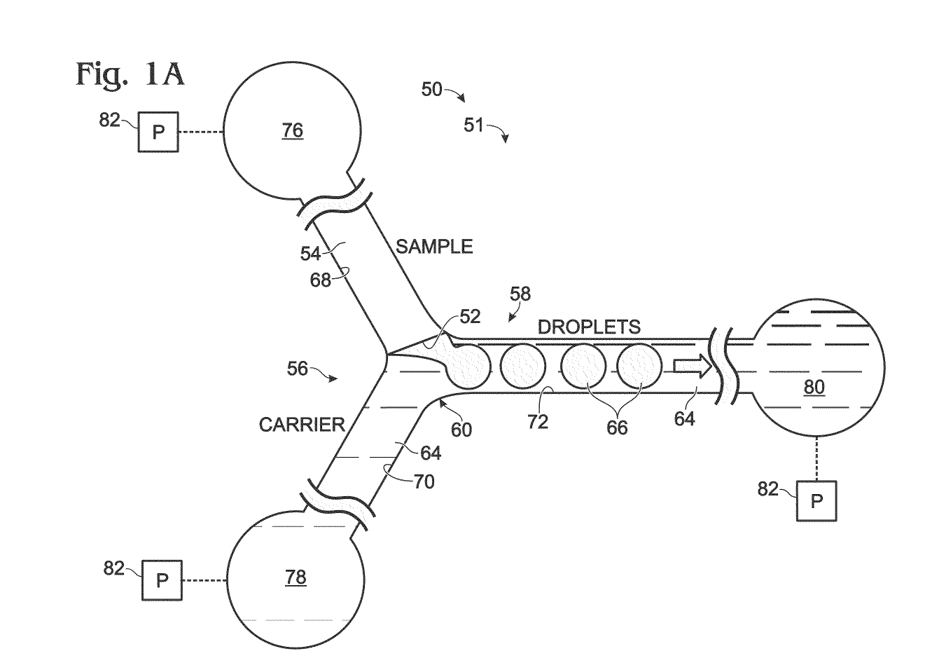

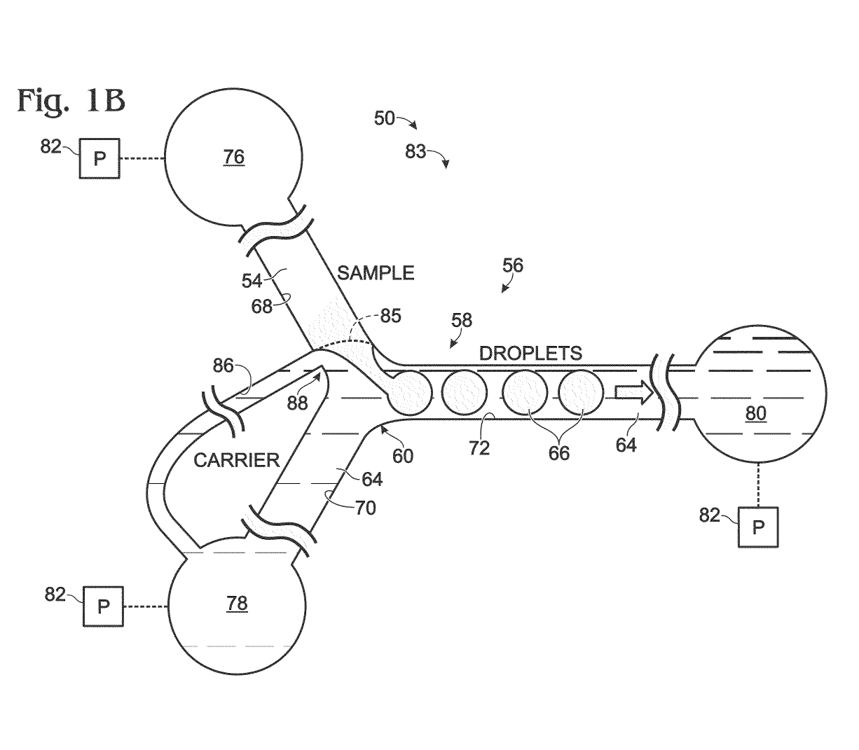

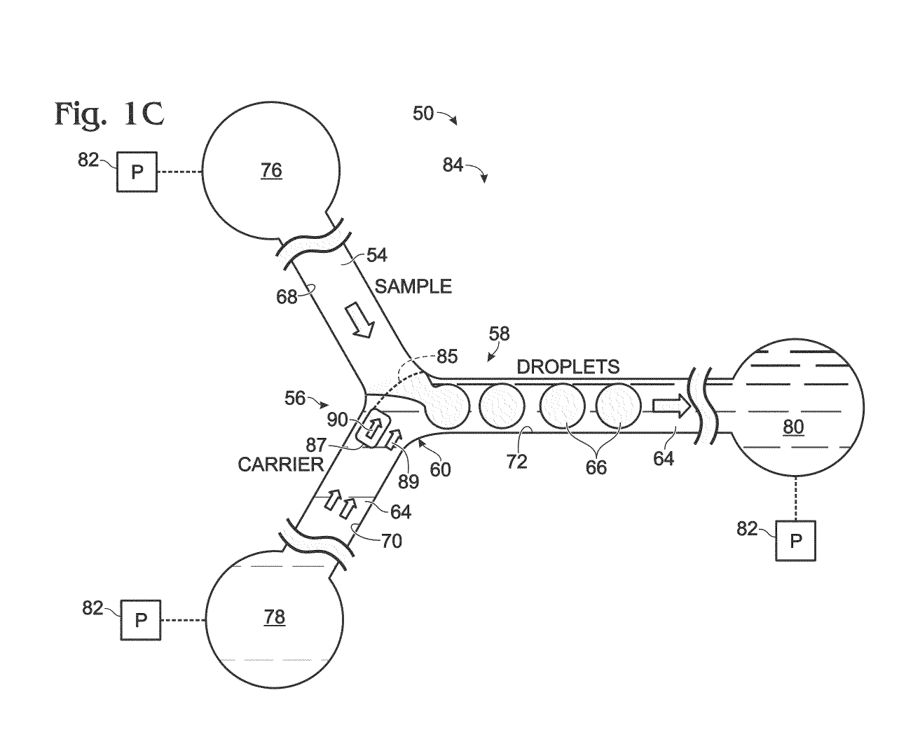

This section presents an overview of an exemplary droplet generation system 50, namely, a system embodiment 51 including a step 52 (interchangeably termed a step member) with an edge forming a wetting boundary for a sample 54, to reduce or eliminate transient effects during droplet generation; see FIG. 1A.

System 51 includes a channel network 56 forming a droplet generation region 58 having a channel junction 60 (interchangeably termed a flow junction). The channel network can hold a sample 54 (interchangeably termed a sample fluid or dispersed phase) and an immiscible carrier fluid 64 (interchangeably termed a carrier or continuous phase) that flow to channel junction 60. Droplets 66 may be formed by dividing a stream of sample 54 in the vicinity of the channel junction. The droplets formed are carried away from the channel junction in carrier fluid 64.

Channel network 56 provides a plurality of channels, such as channels 68, 70, and 72, that may intersect at channel junction 60. At least one sample input channel 68 directs a stream of sample 54 to the channel junction. Also, one or more carrier input channels 70 direct carrier fluid 64 to the channel junction. Furthermore, at least one output channel 72 carries sample droplets 66 in carrier fluid 64 away from the channel junction as an emulsion. The channels may have any suitable dimensions. For example, each channel may have a width of about less than about one millimeter, such as less than about 200, 100, 50, 20, 10, 5, or 1 micrometers, among others. The channel also may have a depth of less than about one millimeter, such as about 200, 100, 50, 20, 10, 5, or 1 micrometers, among others. The width and depth may (or may not) differ from each other by less than about 10-, 5-, or 2-fold, among others. The droplets generated may have any suitable volume, such as less than about 1 microliter, 100, 10, or 1 nanoliters, or 100, 10, or 1 picoliters, among others.

The channel network may be planar. In other words, the input channels and the output channel, particularly near the channel junction, may be at least substantially coplanar. The channel network may have opposing channel surface regions spaced from each other in a direction transverse (e.g., orthogonal) to the plane of the channel network. Each of the opposing channel surfaces region may be at least generally parallel to the same plane, with the height (interchangeably termed the depth) of the channel network at a given position being measured from one of the opposing surface regions to the other opposing surface region in a direction transverse (e.g., orthogonal) to the plane. One of the opposing surface regions may be described as a floor and the other opposing surface region as a ceiling, whether the plane of the channel network is oriented horizontally, vertically, or otherwise during droplet generation.

Step 52 may be defined by the channel network along a path traveled by the sample. The step may be defined at channel junction 60 and/or upstream of the channel junction in sample input channel 68, such as near the channel junction in sample input channel 68, among others. Near the channel junction means spaced from the channel junction by a distance that is less than about twice the width, one width, or one-half the width of the sample input channel, measured parallel to the channel network plane.

The step may create a wetting boundary as an abrupt change in orientation (such as slope) of adjoining wall regions of the channel network. The wall regions may be contiguous floor regions, ceiling regions, or lateral side wall regions of the channel network. For example, the step may be formed by an abrupt decrease in elevation of the floor or an abrupt increase in elevation of the ceiling (or both) of the channel network, generally resulting in a change in the depth of the channel network where the step occurs. Accordingly, the wetting boundary may be formed by an abrupt increase in height/depth of the channel network along a travel path of the sample. Alternatively, or in addition, the step may be formed by an abrupt change in orientation of one or both lateral side walls of the sample input channel. For example, the step may be formed by an abrupt increase in width of the sample input channel. The step may create a convex corner (e.g., with an angle of about 45-135, 60-120 degrees, or about 90 degrees, among others). The convex corner may define an edge of the step oriented transverse to the long axis of the sample input channel. The edge may be at least generally parallel or orthogonal to the plane of the channel network (e.g., within about 20 or 10 degrees of parallel or orthogonal). Because the convex corner and edge are formed by a change in contour that is sufficiently abrupt to serve as a wetting boundary, the corner may be described as sharp.

Channel network 56 may be in fluid communication with a plurality of reservoirs, 76, 78, and 80, that supply fluid to or receive fluid from channels 68, 70, and 72. Each reservoir may or may not be structured as a well. Each well may be open at the top or may be covered and/or sealed. In some embodiments, the well may be sealed by a pierceable sealing member.

Fluid may be driven from reservoirs 76 and 78 to reservoir 80 by application of pressure. The system may be equipped with at least one pressure source 82 that can be operatively connected to one or more reservoirs and/or channels to apply a positive pressure upstream of the droplet generation region (e.g., at reservoirs 76, 78) and/or to apply a negative pressure downstream of the droplet generation region (e.g., at reservoir 80).

A “sample,” as used in the present disclosure, may be any fluid phase capable of being divided into a dispersed phase that is surrounded by a continuous phase. The sample may, for example, be or include a representative material, composition, or substance for any suitable purpose, including analysis, processing, synthesis, manufacturing, or a combination thereof, among others. For example, the sample may be configured to grow particles, such as nanoparticles, may be configured to produce or process chemical and/or biochemical compounds, and/or may be configured to be analyzed by performance of at least one assay.

Sample 54 and/or droplets 66 may have any suitable composition. The sample and/or droplets may be substantially or at least predominantly liquid. The sample and/or droplets may (or may not) be aqueous, may contain particles (e.g., beads), may contain an analyte (e.g., a nucleic acid, protein, lipid, biological cell, virus, small molecule, or the like) and/or a surfactant, and/or may be configured to be analyzed, such as to perform an assay for the analyte (e.g., an amplification assay of a target (such as a nucleic acid target)). In some embodiments, the sample may contain nucleic acid. The concentration of nucleic acid, such as DNA, may be limited to the concentration in which droplet formation is disrupted due to the high concentration of polymeric molecules and viscosity change due to nucleic acid concentration. This concentration may change depending on droplet size and may be about 0-200 ng/uL for droplets approximately one nanoliter in size. The nucleic acid can have any suitable average length, such as less than about 100, 500, or 1000 nucleotides, or at least about 1000 nucleotides, among others. A relatively long nucleic acid, such as having a length of at least several thousand nucleotides, may exhibit considerable viscoelastic nature, which can create problems for droplet generation when flow is not homogeneous.

The sample may contain at least one reporter for any assay. The reporter may, for example, be luminescent, such as photoluminescent, chemiluminescent, or the like. Accordingly, data may be collected from the reporter in the droplets, such as by detection of light from the droplets. The data may be processed to determine a characteristic of the sample, such as a presence, concentration, activity, or the like, of an analyte in the sample.

Carrier 64 may be any fluid that is substantially immiscible with sample fluid 54, and may be substantially or at least predominantly liquid. The carrier may be described as oil and may include at least one surfactant. The carrier may be an oil phase comprising at least one oil, but may include any liquid (or liquefiable) compound or mixture of liquid compounds that is immiscible with water (e.g., to form a water-in-oil emulsion). The oil may be synthetic or naturally occurring. The oil may or may not include carbon and/or silicon, and may or may not include hydrogen and/or fluorine. The oil is hydrophobic and may be lipophilic or lipophobic. In other words, the oil may be generally miscible or immiscible with organic solvents. Exemplary oils may include at least one silicone oil, mineral oil, fluorocarbon oil, vegetable oil, or a combination thereof, among others. In exemplary embodiments, the oil may be a fluorinated oil, such as a fluorocarbon oil, which may be a perfluorinated organic solvent. In other cases, the carrier may be aqueous, and the sample may be predominantly oil and/or another fluid immiscible with water (e.g., to form an oil-in-water emulsion).

Further aspects of samples, carrier fluids, droplets, digital assays that can be performed with droplets, channels, droplet generation regions, and device configurations, among others, that may be suitable for droplet generation systems having an edge defining a wetting boundary are disclosed elsewhere herein, such as in Sections II and III, and in the patent documents listed above under Cross-References, which are incorporated herein by reference.

### II. DROPLET GENERATION SYSTEM WITH A BARRIER LAYER OF CARRIER FLUID

This section presents an overview of exemplary droplet generation systems 50, namely, system embodiments 83 and 84, that form a barrier layer 85 of carrier fluid adjacent the sample, at a position upstream of the site of droplet generation; see FIGS. 1B and 1C. The systems may form the barrier layer with carrier fluid directed by at least one auxiliary channel 86 (see FIG. 1B) or by at least one flow-modifying structure 87 projecting into at least one carrier input channel (see FIG. 1C).

FIG. 1B schematically depicts an exemplary system 83 for droplet generation in which the position of sample fluid 54 is affected by barrier layer 85 of carrier fluid. System 83 of FIG. 1B is substantially similar in many respects to system 51 of FIG. 1A, and the same reference numbers will be used to indicate similar or identical elements.

More specifically, system 83 includes a channel network 56 forming a droplet generation region 58 disposed at a first channel junction 60, and a second channel junction 88 disposed upstream from the droplet generation region. As in system 51 of FIG. 1A, the channel network can hold sample 54 and an immiscible carrier or carrier fluid 64 that flow to the channel junctions, and droplets 66 (formed from sample 54) disposed in the carrier and flowing away from the channel junction.

Channel network 56 provides a plurality of channels 68, 70, and 72 that intersect at channel junctions 60 and 88. At least one sample input channel 68 directs sample 54 to each channel junction. First and second carrier input channels 70 and 86 direct carrier fluid 64 to the first and second channel junctions 60 and 88, respectively. Output channel 72 carries sample droplets 66 in carrier fluid 64 away from downstream channel junction 60.

As in system 51 of FIG. 1A, channel network 56 of system 83 may be in fluid communication with a plurality of reservoirs 76, 78, and 80 that supply fluid to or receive fluid from channels 68, 70, and 72. Each reservoir may or may not be structured as a well. Each well may be open at the top or may be covered and/or sealed. In some embodiments, the well may be sealed by a pierceable sealing member.

Also as in system 51 of FIG. 1A, fluid in the system of FIG. 1B may be driven from reservoirs 76 and 78 to reservoir 80 by application of pressure. The system may be equipped with at least one pressure source 82 that can be operatively connected to one or more reservoirs and/or channels to apply a positive pressure upstream of the droplet generation region (e.g., at reservoirs 76 and 78) and/or to apply a negative pressure downstream of the droplet generation region (e.g., at reservoir 80). In system 83 of FIG. 1 B, carrier fluid driven from reservoir 78 will pass through both first carrier input channel 70 and second carrier input channel 86. In other cases, fluid in channels 70 and 86 may be supplied by distinct reservoirs, and may (or may not) have the same composition as each other.

As in system 51 of FIG. 1A, sample 54, carrier fluid 64 and/or droplets 66 of the system may have any suitable composition, provided the carrier fluid is immiscible with the sample fluid. These aspects of the system have already been described in detail above and will not be described further here.

Carrier fluid barrier layer 85 that forms a boundary separating sample fluid from one or more walls of the channel network is generally produced by carrier fluid entering sample input channel 68 from second carrier input channel 86 at second channel junction 88. Specifically, carrier fluid entering the second channel junction from the second carrier input channel forms a barrier layer between at least one surface of the sample input channel and sample fluid. For example, if carrier input channel 86 intersects sample input channel 68 at or near the top surface or ceiling of the sample input channel, then the carrier fluid entering channel 68 from channel 86 will form a barrier layer between the ceiling of the sample input channel and sample fluid passing through the channel. Similarly, if carrier input channel 86 intersects sample input channel 68 at or near the bottom surface or floor of the sample input channel, then the carrier fluid entering channel 68 from channel 86 will form a barrier layer between the floor of the sample input channel and sample fluid passing through the channel.

The barrier layer formed by carrier fluid entering channel 68 from channel 86 is created for the purpose of minimizing or even eliminating transient wetting effects that can occur as surfactants present in the sample fluid gradually bind to one or more surfaces of the channel network in the region of droplet generation. Thus, the second channel junction should be disposed upstream from the first channel junction by a sufficiently small distance so that carrier fluid entering the second channel junction from the second carrier input channel forms a barrier layer between at least one surface of the sample input channel and sample fluid in a region of the sample input channel extending between the second channel junction and the first channel junction. This region extending between the second channel junction and the first channel junction should be understood to include any portion of the droplet generation region within which accumulating surfactants would result in a transient droplet generation effect.

As depicted in FIG. 1B, second carrier input channel 86 may intersect sample input channel 68 from only one side of the sample input channel. In other cases, the second carrier input channel may intersect the sample input channel from two sides, which may be substantially opposite to each other. Furthermore, additional carrier input channels may be utilized to create carrier fluid barrier layers near more than one surface of the channel network, such as near the ceiling and floor surface regions of the sample input channel. Alternatively, sample input channels such as the channel depicted in FIG. 1B may be combined with convex corners or other similar features to create a combination of at least one edge-defined wetting boundary and at least one carrier fluid barrier layer (e.g., see Example 7).

FIG. 1C shows another exemplary system 84 for droplet generation with sample position affected by barrier layer 85 of carrier fluid. The system of FIG. 1C is similar to the system of FIG. 1B, except that flow of carrier fluid to form barrier layer 85 is directed by at least one flow-modifying structure 87 projecting into least one primary carrier input channel, rather than by an auxiliary channel. Each flow-modifying structure interchangeably may be described as a director, obstacle, feature, constriction, router, or weir.

Each flow-modifying structure 87 may be formed in a carrier input channel. The flow-modifying structure additionally (or alternatively) may extend into and/or may be at least partially formed at a channel junction 60 where sample input channel 68 meets at least one carrier input channel 70. Accordingly, the flow-modifying structure may be disposed at or near channel junction 60, meaning that at least a portion of the flow-modifying structure projects into channel junction 60 and/or is positioned within about two or one carrier input channel widths from the channel junction.

One or more flow-modifying structures 87 may direct portions of carrier fluid in the same channel(s) for different purposes. A first portion of the carrier fluid, generally a majority of the carrier fluid (such as at least about 60%, 75%, or 90%, among others) may be directed by one or more flow-modifying structures 87 to the sample stream as a dividing flow 89 that divides the sample stream into droplets. A second portion of the carrier fluid, generally a minority of the carrier fluid (such as less than about 40%, 25%, or 10%, among others) may be directed by the one or more flow-modifying structures to a more upstream position of the sample stream as a barrier flow 90 (e.g., a lubricating flow) that forms barrier layer 85. Further aspects of flow-modifying structures 87 are described elsewhere in the present disclosure, such as in Example 10.

Further aspects of samples, carrier fluids, droplets, digital assays that can be performed with droplets, channels, droplet generation regions, and device configurations that may be suitable for droplet generation systems forming a barrier layer are described elsewhere herein, such as in Sections I and III, and in the patent documents listed above under Cross-References, which are incorporated herein by reference.

### III. EXAMPLES

This section describes selected aspects and embodiments of the present disclosure related to droplet generation with features for sample positioning. These examples are intended for illustration only and should not limit or define the entire scope of the present disclosure. The features disclosed in this section may be combined with each other and with features disclosed in Sections I and II.

### Example 1

### Droplet Generation with Undesired Variability

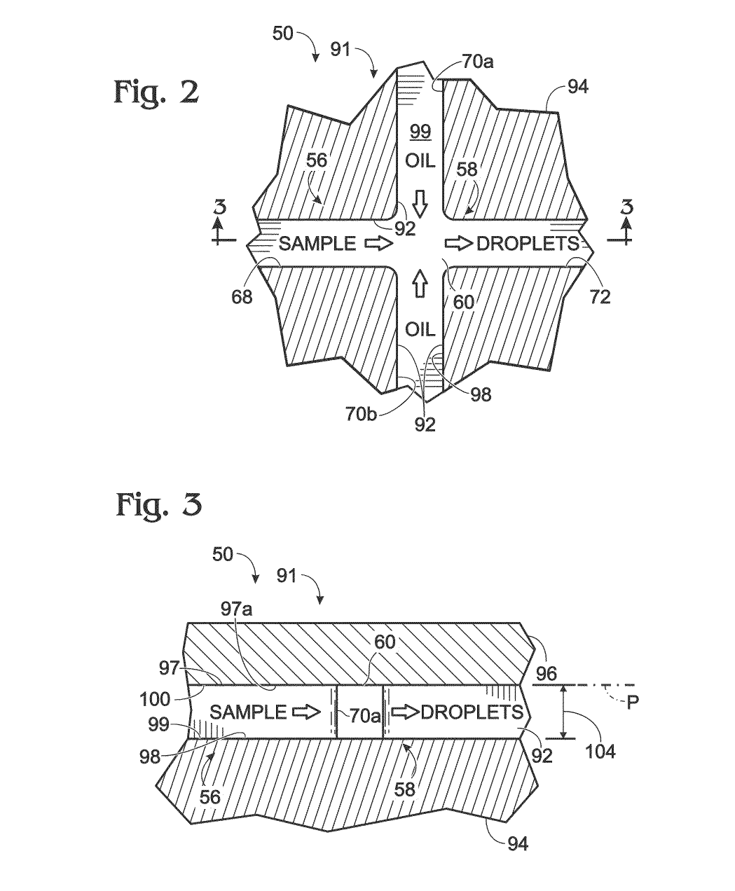

This example describes undesired variability in generated droplet size that can occur in a droplet generation system as a function of time, phase composition, and/or sample viscoelasticity, among others; see FIGS. 2-8.

FIGS. 2 and 3 show an exemplary device 91 for droplet generation in system 50. Device 91 does not have any of the features described above in Sections I and II for sample positioning. However, any of the structure, components, and features of device 91 may be applicable to, and included in, any of the droplet generation devices described elsewhere herein. In FIG. 2, and in many of the drawings that follow, the term “oil” is used as an exemplary shorthand for “carrier,” and is not intended to limit the type of carrier fluid used.

Device 91 has a cross-shaped, planar arrangement of channels 68, 70a, 70b, and 72 that meet at channel junction 60 to create droplet generation region 58 (FIG. 2). Channel network 56 has lateral side walls 92 that bound each of the channels laterally.

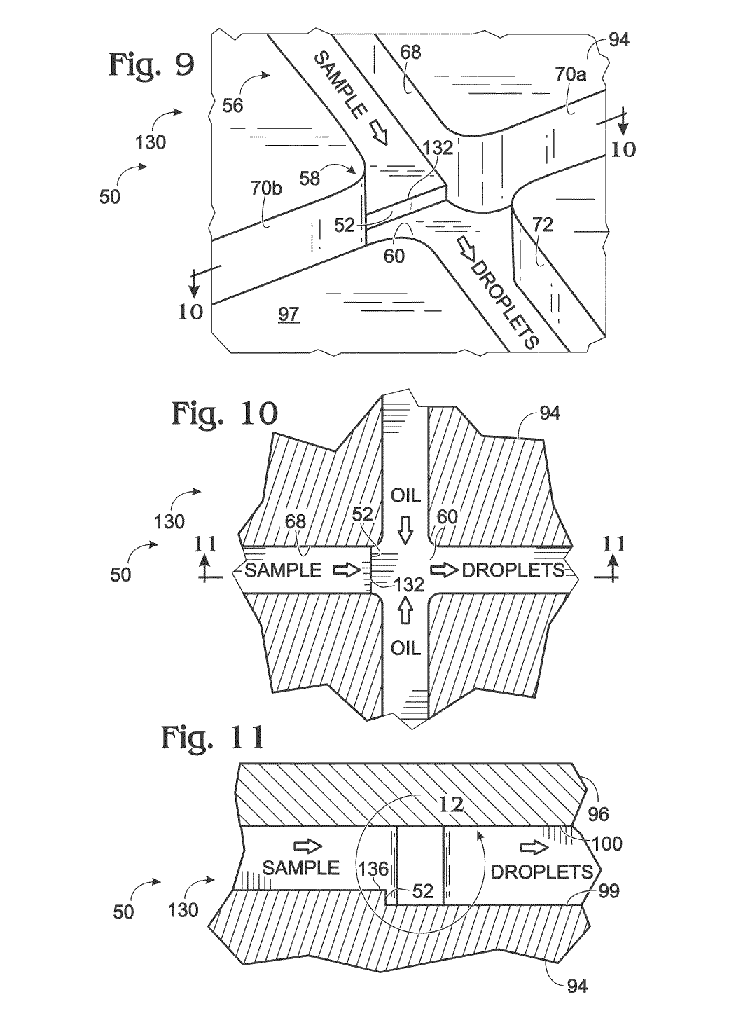

FIG. 3 shows a cross-sectional view of device 91. Channels 68, 70a, 70b, and 72 each may be formed cooperatively by a base 94 attached to a cap 96. The base and cap may provide a base surface 97 and a cap surface 97a that face and abut one another to define a plane, P. Base surface 97 may define one or more recesses 98, such as one or more grooves, that form a portion of each channel (also see FIGS. 2 and 9), such as lateral side walls 92 and a floor 99 thereof. The base and cap may be attached to each other by any suitable mechanism, such as bonding (e.g., assisted by heat, pressure, solvent, irradiation with electromagnetic radiation) and/or with an adhesive, among others.

The base interchangeably may be termed a base member, a recessed member, and/or a body member. Furthermore, to facilitate the description, the base may be described as a lower member, if the droplet generation device is oriented, literally or conceptually, to position base 94 under cap 96. The use of the terms top and bottom, upper and lower, ceiling and floor, and similar positional terms, are intended to describe aspects of the device using a frame of reference defined by the device, and not gravity (or lack thereof), unless specified otherwise. In other words, the positional terms may not be defined by the orientation in which the droplet generation device is operated. For example, the droplet generation device may be operated with the base below the cap or above the cap (e.g., with a plane defined by channel network 56 oriented horizontally), or with the base and the cap side-by-side (i.e., horizontally offset from one another, e.g., with the plane of channel network 56 oriented vertically instead of horizontally).

Base 94 may be formed by any suitable approach. The base and/or recesses 98, may be molded (e.g., injection-molded), etched, machined, created by lithography (e.g., multi-layer lithography and/or soft lithography), and/or the like.

Cap 96 may be any member that cooperates with base 94 to define and enclose channels of the channel network, generally by covering recesses 98. The cap interchangeably may be termed a capping layer, a cover, a cover member, and/or a sealing member. Cap 96 may provide cap surface 97a that is planar. Cap surface 97a may (or may not) be substantially featureless, that is, the cap surface may define no projections or recesses that contribute substantively to the shape of channels 68, 70a, 70b, and 72. The cap may form a ceiling 100 of the channel network and/or of each channel, and may not substantially define any other part of the channels, such as lateral side walls 92. In other embodiments, the cap may define at least part of lateral side walls 92. If the cap is structured as a sheet, the sheet may be a film having a thickness of less than about 1000, 500, or 250 micrometers, among others.

Channel network 56 and/or any combination of channels 68, 70a, 70b, and 72 of device 91 may define a plane that is parallel to plane P. A depth 104 (interchangeably termed a height) of a region of the channel network (e.g., a channel depth or height) can be measured orthogonal to the plane, generally from floor 99 to ceiling 100 of the region.

Further aspects of suitable structure for device 91, or any of the related droplet generation devices disclosed herein, are described in the patent documents listed above under Cross-References, which are incorporated herein by reference, particularly U.S. Patent Application Publication No. 2010/0173394 A1, published Jul. 8, 2010; U.S. Patent Application Publication No. 2012/0152369 A1, published Jun. 21 2012; and U.S. Patent Application Publication No. 2012/0190032 A1, published Jul. 26, 2012.

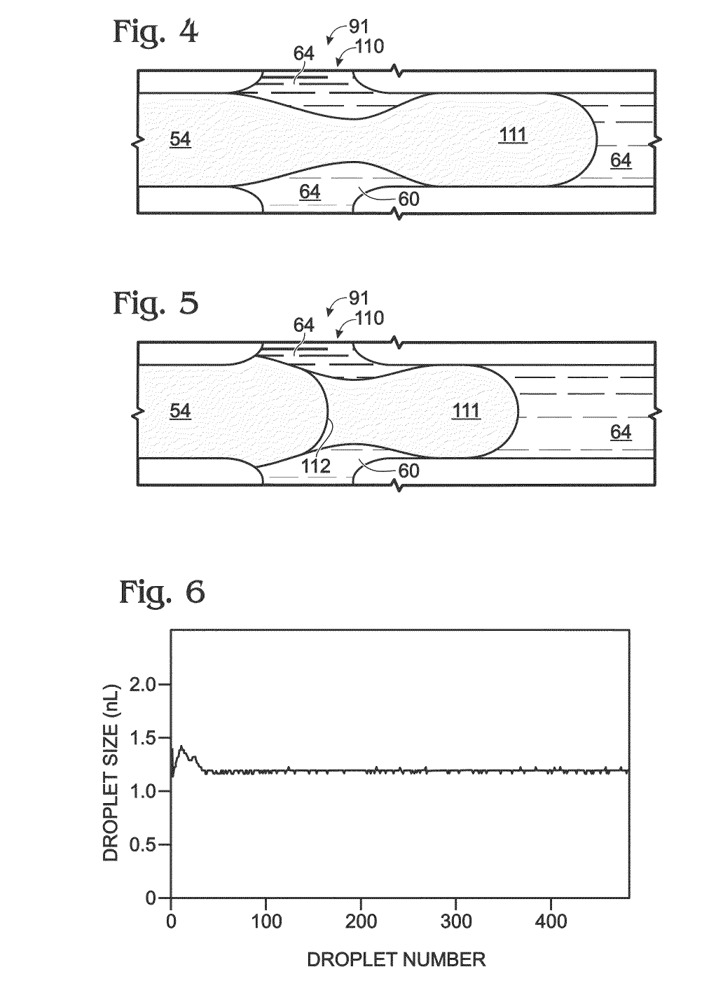

FIGS. 4 and 5 show line drawings of exemplary images collected generally around a droplet-generating portion of a physical model 110 of device 91 (see FIGS. 2 and 3).

FIG. 4 shows an early time point in a droplet production run. Sample 54 has not yet substantially wetted the floor region or ceiling region of channel junction 60. (The floor and ceiling of the channel network are parallel to the plane of the image.) As a result, shear forces exerted by carrier fluid 64 on sample 54 have caused the sample stream to be pinched at channel junction 60, with a prospective droplet 111 almost completely separated from the sample stream while the tail end of the prospective droplet is still at the channel junction. Accordingly, at this early time point the geometry in the vicinity of the channel junction can play a major role in determining droplet size.

FIG. 5 shows a later time point in the same droplet production run. Sample 54 has wetted the ceiling of channel junction 60 to establish a wetting line 112 at the channel junction. As a result, droplets form farther downstream and are smaller than droplets generated with the fluid configuration of FIG. 4. Therefore, droplet size may vary within a droplet production run as the extent of sample wetting at the channel junction changes.

FIG. 6 shows a graph of measured droplet size in nanoliters plotted according to droplet position number within a droplet production run, performed using physical model 110 of FIGS. 4 and 5. The volume of generated droplets is variable early in the production run and then stabilizes and remains substantially constant for the remainder of the run. The incorporation of any of the sample-positioning features described above in Sections I and II can help to establish a stable position of the sample stream very early in a droplet production run, which can reduce or substantially eliminate the variability in droplet size seen here (e.g., see Example 4).

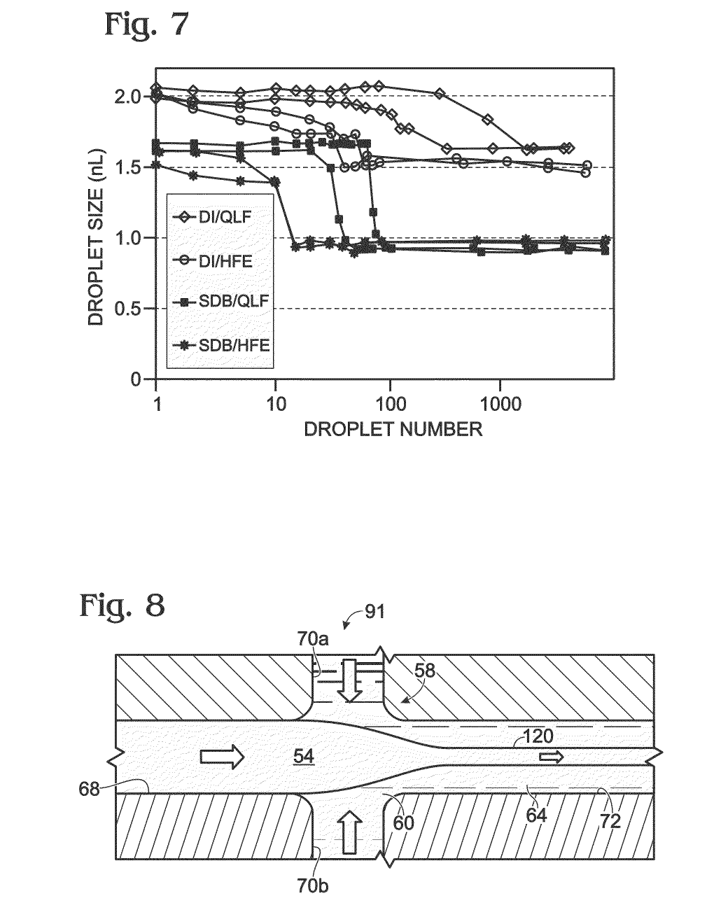

FIG. 7 shows a graph of data collected generally as in FIG. 6 but for multiple droplet production runs testing different sample and carrier compositions. For each composition tested, a transient of larger droplets was observed at the beginning of the run, which transitioned sooner or later to a smaller droplet size for the remainder of the run. The duration of the transient was found to be a function of wetting agents in both the dispersed (i.e., sample) and continuous (i.e., carrier) phases.

The conditions tested in FIG. 7 are as follows. The continuous phase was fluorocarbon oil HFE 7500 (“HFE”) or HFE 7500 with surfactant (“QLF”). The dispersed aqueous phase was composed of a buffer with surfactant (“SDB”) or deionized water without surfactant (“DI”). The transients observed in FIG. 7 were quite variable in duration, lasting for as short as about 10 droplets and as long as about 1000 droplets into the run, depending on phase composition. The droplet generation rate for these tests was between 250 and 500 Hz and the total run used 20 μL of sample, to generate roughly 20,000 droplets of roughly one nanoliter volume. The variability in droplet size during the course of a run, while affected by surfactants, was observed with any combination.

FIG. 8 shows a schematic view of the droplet generation region of device 91 during a droplet production run with a sample 54 that is viscoelastic. With sufficient flow rates of sample and carrier fluid, the sample fails to be partitioned into droplets. Instead, the sample forms a narrow stream 120 of sample that extends continuously downstream of channel junction 60 into droplet output channel 72. In other cases, droplet generation does not fail completely but is erratic and unpredictable. The sample may gradually wet the floor and/or ceiling with the sample wetting line migrating downstream. Once the sample wetting line is downstream of the channel junction, the droplets generated can become less uniform in size due to the lack of geometric control of droplet formation normally provided at the channel junction.

The sample-positioning features disclosed elsewhere herein may be used separately or in combination to mitigate the initial transient (FIGS. 6 and 7) and/or to increase robustness in generating droplets from viscoelastic samples (FIG. 8).

### Example 2

### Exemplary Wetting Boundary Formed by a Step

This example describes exemplary droplet generation devices having a wetting boundary formed by a step located at or upstream of a channel junction; see FIGS. 9-16. The devices of this example may have any suitable combination of the features disclosed elsewhere in the present disclosure, such as in Sections I and II and Example 1, among others, and/or in the patent documents listed above under Cross-References, which are incorporated herein by reference.

FIG. 9 shows a fragmentary, generally top view of an exemplary droplet generation device 130 having a step 52 produced by an abrupt change in the depth of channel network 56. (In this view, cap 96, which provides a ceiling of the channel network, has been removed to simplify the presentation.)

FIG. 10 shows a fragmentary sectional view of device 130. Step 52 may be formed at channel junction 60 and/or upstream of the channel junction in sample input channel 68. The step may extend between opposing lateral side wall regions of sample input channel 68. Also, the step may create an edge 132 (also termed a surface discontinuity) arranged transverse to the long axis of sample input channel 68 and contacted by a stream of sample 54. Edge 132 may be transverse (e.g., substantially orthogonal) to a long axis defined adjacent channel junction 60 by the sample input channel.

FIG. 11 shows a fragmentary sectional view of device 130 in the presence of cap 96. Step 52 may be defined by a region of floor 99 of the channel network, which is formed by base 94. The step may create a convex corner 136 defining an angle of substantially less than 180 degrees (e.g., about 90-135 degrees, or about 90 degrees, among others). The step may represent an increase in depth of the channel junction relative to the sample input channel. The increase in depth may extend for any suitable distance downstream of the step in the droplet output channel and/or any suitable distance upstream of the channel junction in the carrier input channel(s). In other examples, any of the steps or other surface discontinuities disclosed herein may be formed by one or more lateral side wall regions of the channel network (e.g., by side walls provided by base 94), or by cap 96 to create a step and/or convex corner defined by the ceiling of the channel network, among others.

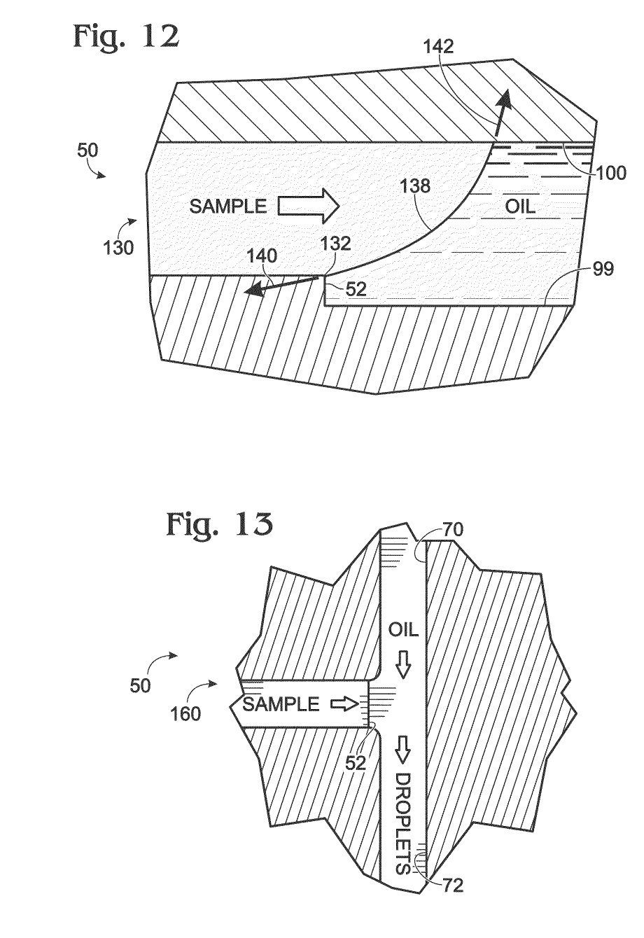

FIG. 12 shows a more schematic sectional view of device 130 taken generally at the region indicated at “12” in FIG. 11 in the presence of two liquid phases, namely, sample and carrier (“oil”). The position of an interface 138 formed between the two liquid phases depends, at least in part, on capillary forces at the channel walls, such as forces 140, 142 at floor 99 and ceiling 100, respectively, at or near the channel junction of the device. Here, step 52 establishes a wetting boundary for the sample along floor 99. Also, the step rotates floor force vector 140 such that the net floor and ceiling forces 140, 142 generally oppose each other to stop downstream sample wetting of ceiling 100 driven by force vector 142, to create a sample wetting line on ceiling 100. Other features, such as a projection (e.g., a ridge), a recess (e.g., a groove), a set of recesses and/or projections, or the like, that affect capillary flow in general can have a similar effect during droplet generation.

FIG. 13 show a fragmentary sectional view of an exemplary droplet generation device 160 having a step 52 (see FIGS. 9-12) and a T-shaped arrangement of channels. In other embodiments, the channels may be disposed in a Y-shaped arrangement. In any event, the device may have a single input channel 70 for carrier fluid.

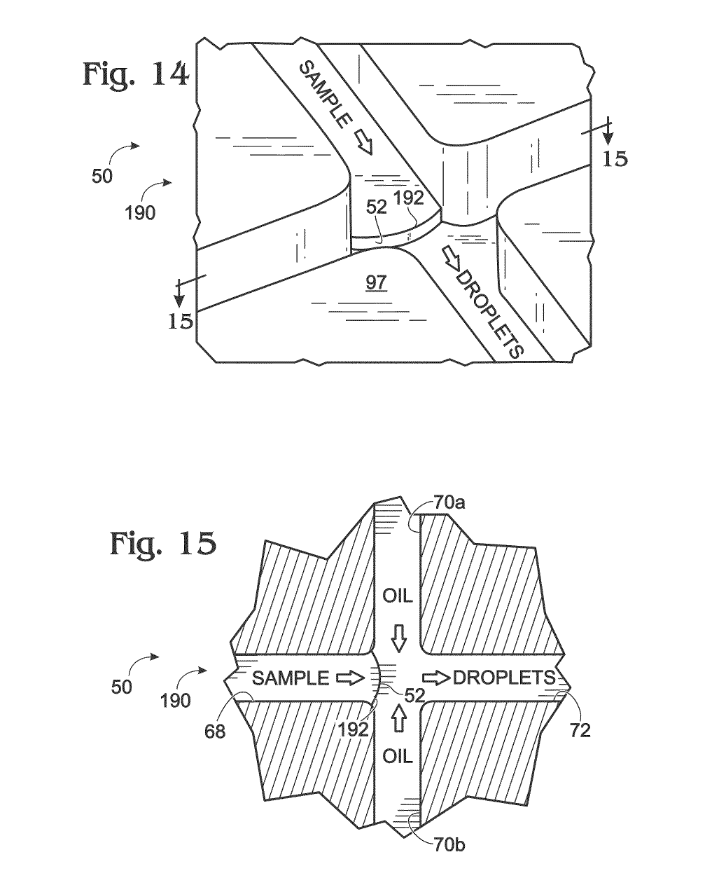

FIGS. 14 and 15 show another exemplary droplet generation device 190, viewed as in FIGS. 9 and 10 for device 130. Device 190 is similar to device 130 except that the device has an arcuate wetting boundary created by a curved step 52. The step has a curved edge 192, rather than linear edge 132 present in device 130 (compare FIGS. 10 and 15). The use of a curved step may allow the step to extend between respective lateral side walls of carrier input channels 70a and 70b, while still forming an edge region that is transverse to the sample input channel. In any event, each step may provide an edge that is straight, angularly bent, curved, or a combination thereof, among others.

FIG. 16 shows an exemplary droplet generation device 220 viewed generally as in FIG. 10. Here, however, step 52 is flush with a pair of lateral side walls of carrier input channels 70a and 70b, rather than being positioned upstream of the channel junction.

### Example 3

### Exemplary Patterned Wetting Boundary

This example describes exemplary droplet generation systems having a patterned wetting boundary formed by a series of laterally arranged ridges and/or grooves located near and/or at a channel junction; see FIGS. 17-27.

FIG. 17 shows a top view of an exemplary droplet generation device 250 having a micro-patterned wetting boundary 251. The wetting boundary is formed by a series of elongate surface features 252 defined by surface 97a of cap 96. Surface features 252 have sharp edges oriented transverse to the long axis of sample input channel 68 to restrict wicking of the sample across the surface features. The surface features may be at least generally parallel to carrier input channels 70a and 70b, to encourage the carrier fluid to wick along the surface features, thereby further preventing the sample from wicking into the channel junction.

Surface features 252 may provide a redundant wetting boundary for the sample. In other words, the most upstream feature 252 with respect to sample input channel 68 may establish a wetting boundary for the sample. Additional features 252 may further impede sample wetting, if the sample has managed to wick past one or more features upstream. The most upstream feature (i.e., feature 252 or features in the embodiments disclosed below) may be disposed in a position similar to the steps disclosed above. For example, the most upstream feature may be positioned at the channel junction and/or in the sample input channel near the channel junction. In any of the embodiments disclosed herein, instead of a series of surface features, only one surface feature (e.g., a single ridge or groove) may be present near or at the channel junction.

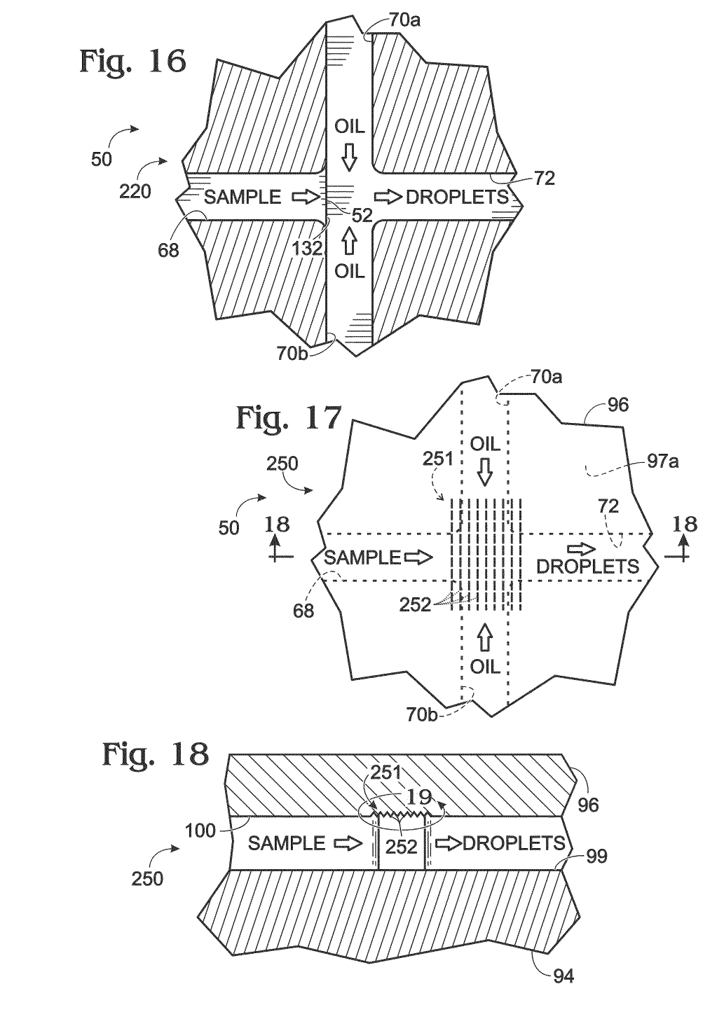

FIG. 18 shows a fragmentary sectional view of device 250. Features 252 may be defined by ceiling 100, which may be provided by a sheet, such as a film. The features (or a single feature) may be created by any suitable mechanism, such as molding, etching (e.g., with a laser), stamping, hot embossing, material deposition, or the like. In other examples, features 252 (or only a single feature) may be defined by a floor 99 of the channel network.

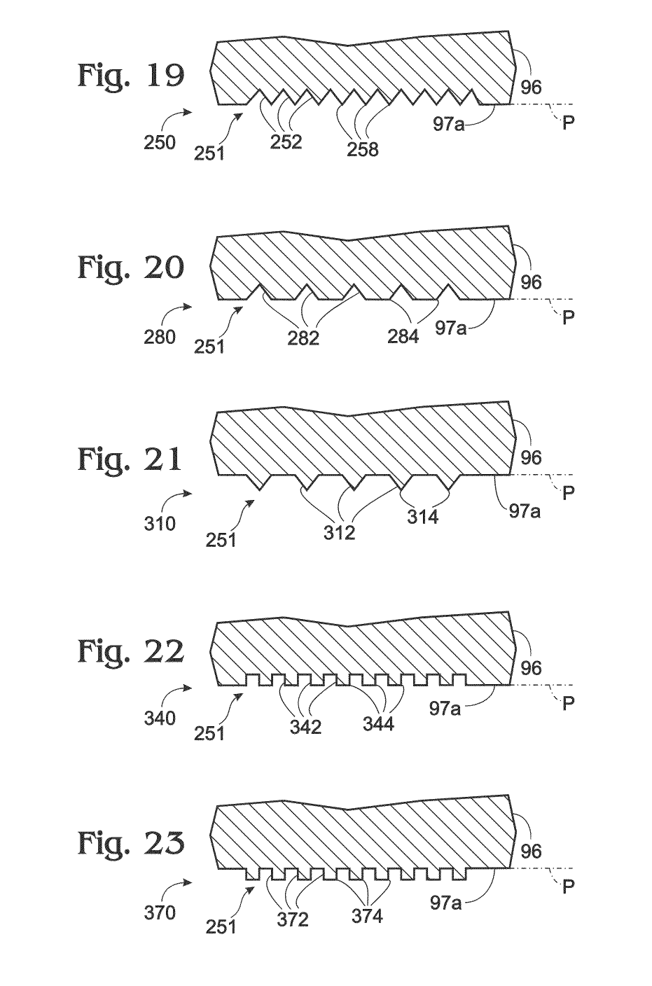

FIG. 19 shows a fragmentary sectional view of cap 96 of device 250, taken generally around surface features 252 at the channel junction. The features may be grooves formed in surface 97a, which defines plane P. The grooves may be triangular in shape to create a series of sharp edges 258 (also termed convex corners) to block sample wetting by capillary action. FIGS. 20-23 show other exemplary surface features that may be utilized at or near the channel junction to establish a sample wetting line.

FIG. 20 shows another exemplary device 280 having triangular grooves 282 as surface features that form a sample wetting boundary with edges 284. Grooves 282 are more widely spaced than in device 250 of FIG. 19.

FIG. 21 shows another exemplary device 310 having a pattern of surface features 312 that form a sample wetting boundary. Here, features 312 are a series of spaced ridges projecting from planar surface 97a of cap 96 to create sharp edges 314 to impede sample wetting.

FIG. 22 shows another exemplary device 340 having a pattern of surface features 342 that form a sample wetting boundary. Here, features 342 are a series of rectangular grooves formed in planar surface 97a of cap 96 to create edges 344 to impede sample wetting.

FIG. 23 shows another exemplary device 370 having a pattern of surface features 372 that form a sample wetting boundary. Here, features 372 are a series of rectangular ridges projecting from planar surface 97a of cap 96 to create sharp edges 374 to impede sample wetting.

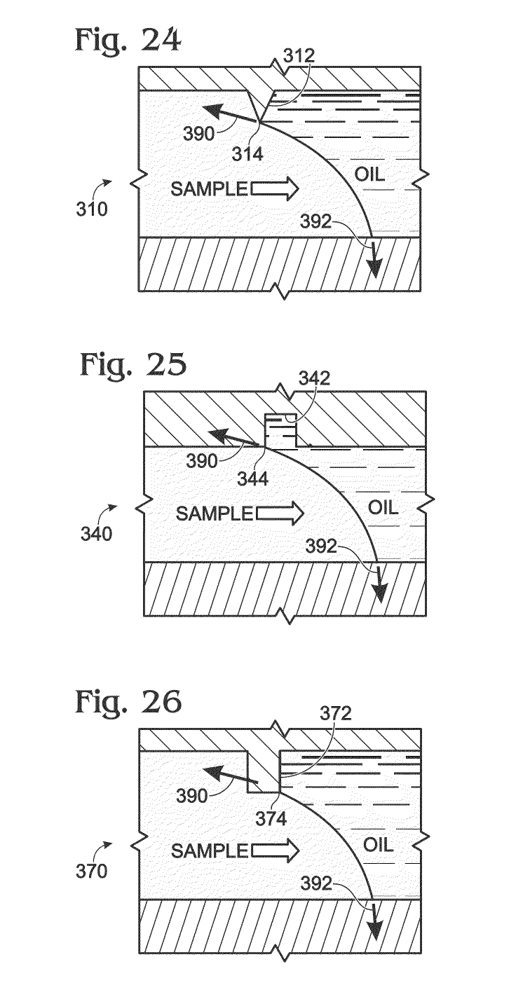

FIGS. 24-26 show schematic, fragmentary sectional views of droplet generation devices 310, 340, and 370, respectively (also see FIGS. 21-23), taken in the presence of sample and carrier fluid to illustrating how only one of surface features 312, 342, or 372 can act as a wetting boundary. In general, any abrupt expansion of a channel can inhibit capillary flow along that channel. This is due to the change of the contact angle of the liquid at the wall relative to the middle axis of the channel. Conversely, a narrowing of the channel will encourage capillary flow. Therefore, simple features such as a projection (e.g., a ridge formed by surface feature 312 or 372 of FIG. 24 or FIG. 26) or a recess (e.g., a groove formed by surface feature 342) that each create both a sudden increase and a sudden decrease in channel depth can also function as a capillary stop. Each surface feature rotates ceiling force vector 390 to generally oppose floor force vector 392, in a manner analogous to that described above in Example 2 for FIG. 12.

It can be seen that a recess or a projection defined by the ceiling (or floor) rotates the force vector of the interfacial tension at the wall to stop sample wetting of both the floor and ceiling. The advantage of achieving this with a relatively small recess or projection is that there is only a minimal impact on the overall channel size and flow resistance that determine the behavior of a droplet generator. The recess or projection can be placed near the entrance to the channel junction or inside the channel junction. Any recess or projection that affects capillary flow in general can have the same effect during droplet generation, where the interface between the two liquid phases depends on the capillary forces at the wall.

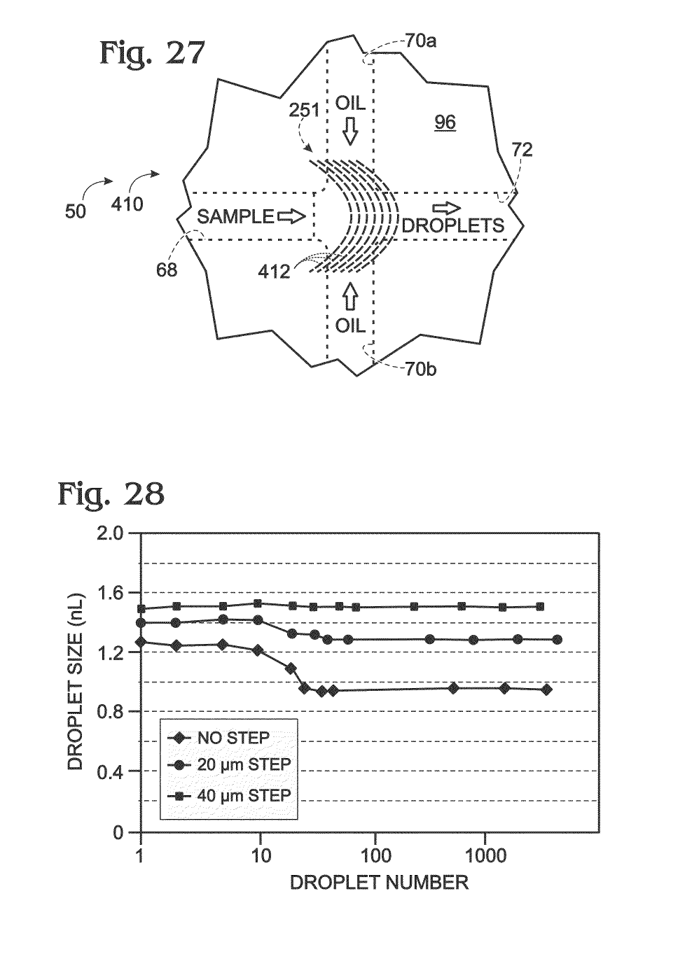

FIG. 27 shows a fragmentary top view of an exemplary droplet generation device 410 with a wetting boundary 251 formed by a series of curved, elongate surface features 412 defined by cap 96 of the device. Each feature may have any of the geometries disclosed above for other droplet generation devices. Each feature may overlap the lateral side walls of carrier input channels 70a and 70b (as shown), one or more lateral side walls of sample input channel 68, or both. Also, only one of surface features 412 may be present.

In other embodiments, at least one wetting boundary may be formed by at least one surface region that has greater surface roughness and/or porosity than surrounding surface regions. The roughness/porosity of the surface region may hold a film or layer of carrier phase and prevent wetting by the sample phase. Each surface region with roughness/porosity may be provided by the base, the cap, or a combination thereof.

A region of surface roughness/porosity may be introduced by any suitable technique. In one approach, a master, used for molding the base, can be roughened at a region corresponding to the desired wetting boundary location by processes such as deep reactive ion etching (DRIE) or chemical etching, among others. The region of localized roughness on the master produces a corresponding region of roughness on the base of the droplet generator during molding. Another approach that may be suitable is a post-molding treatment of the base and/or treatment of the cap, such as by laser machining.

### Example 4

### Exemplary Test Data for a Wetting Boundary

This example describes exemplary data collected from droplet generators constructed according FIGS. 2 and 16 (i.e., with or without a step); see FIG. 28.

FIG. 28 shows a graph of data collected with working models of droplet generation devices with or without a step. The models were fabricated without a geometric wetting boundary (“no step”) or with a step (“20 μm step” or “40 μm step”) positioned as in FIG. 16. Droplet size in nanoliters is plotted as a function of droplet position number within a droplet production run. The presence of a 40 μm step in the device substantially eliminated the droplet size transient observed without a step. The height of the step (or a projection), or the depth of a depression, may represent any suitable percentage of the depth of the channel, such as at least about 5, 10, 25, or 50 percent of the channel depth, among others.

### Example 5

### Exemplary Wetting Boundaries Defined by a Lateral Side Wall

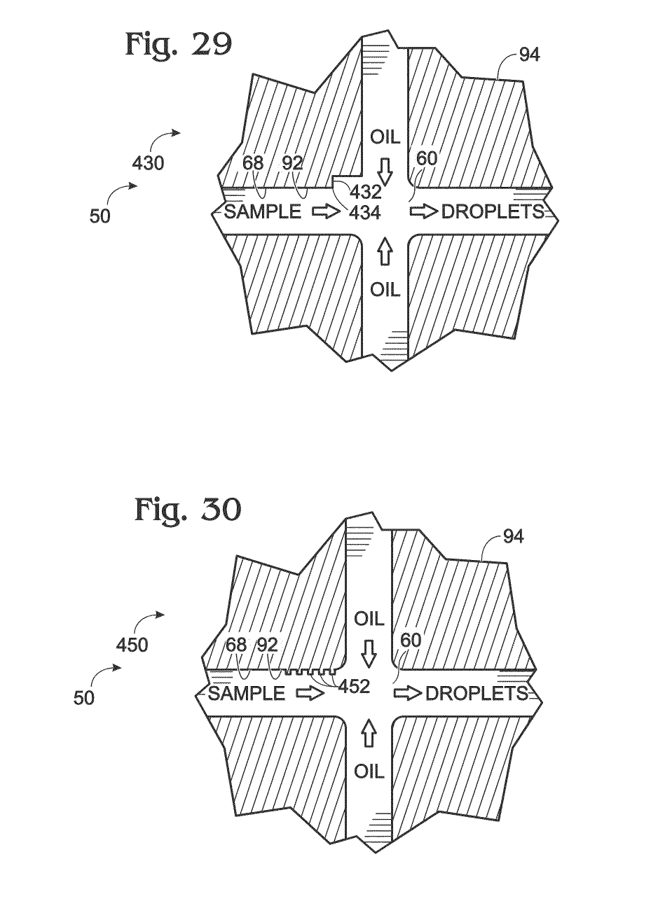

This example describes exemplary droplet generation systems each having a wetting boundary defined by a lateral side wall of the sample input channel; see FIGS. 29 and 30.

FIG. 29 shows an exemplary droplet generation device 430 having a wetting boundary for sample created by a lateral step 432 formed in sample input channel 68. The step produces an abrupt increase in width of channel 68. Step 432 creates a sharp edge 434 defined by lateral side wall 92. FIG. 30 shows an exemplary droplet generation device 450 having a wetting boundary for sample created by a series of surface features 452 defined by lateral side wall 92 of sample input channel 68. The surface features may be projections and/or recesses formed on and/or in the lateral side wall. The surface features may be elongated in a direction transverse (e.g., orthogonal) to the plane of the channel network. The surface features may have any of the geometries described above in Example 3.

In some embodiments, the surface features may be created by injection molding from a complementary mold. For example, a mold structure complementary to the surface features may be etched into the mold, such as with a laser, among others, before the mold is used in an injection molding process to create at least a portion of the channel network (e.g., base 94). Alternatively, the surface features may be etched in a lateral side wall(s) of the channel network after the wall has been formed (e.g., injection molded).

### Example 6

### Exemplary Wetting Boundaries Formed by Arcuate Steps

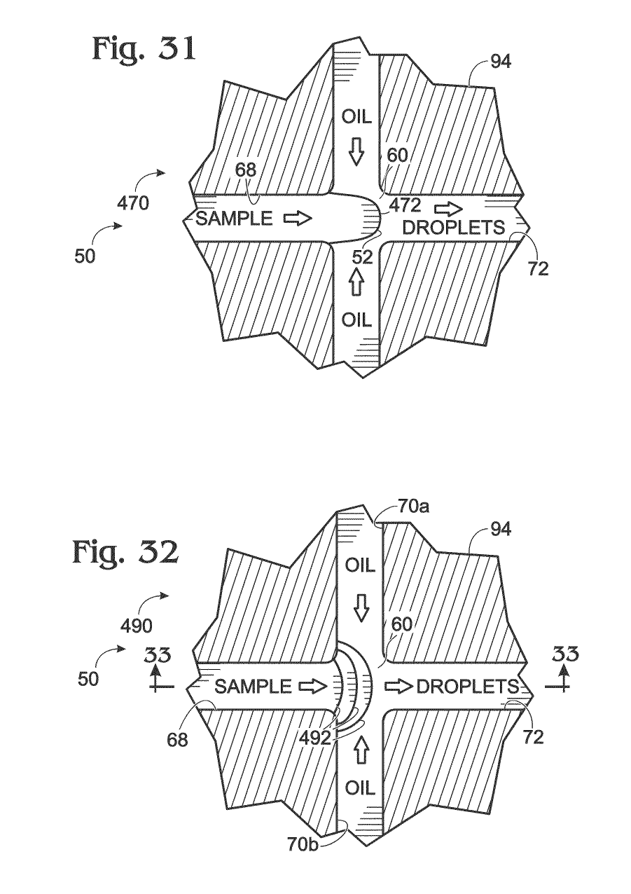

This example describes exemplary droplet generation systems each having a wetting boundary defined by at least one arcuate step; see FIGS. 31-33.

FIG. 31 shows an exemplary droplet generation device 470 having a projecting, arcuate step 472 that forms a wetting boundary. Step 472 may or may not be elongated parallel to the sample input channel and may or may not project across a majority of channel junction 60, for example, at least about 50%, 60%, 70%, or 80% of the distance from sample input channel 68 to output channel 72.

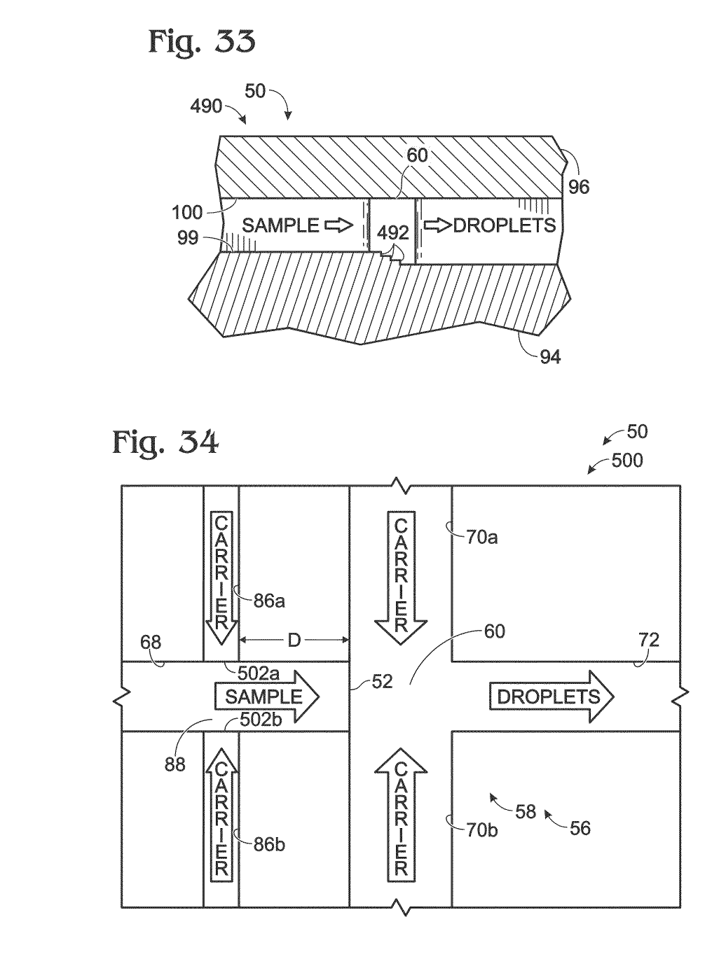

FIGS. 32 and 33 shows an exemplary droplet generation device 490 having a series of arcuate steps 492 formed at channel junction 60. The steps may project different extents across channel junction 60 and may be arranged generally parallel to one another.

### Example 7

### Exemplary Wetting Boundary Produced by a Double Cross Design

This example describes an exemplary droplet generation device 500 having a “double cross” design configured to create a wetting boundary in the form of a boundary layer of carrier fluid to mitigate transient effects during droplet generation; see FIGS. 34-37 (also see Section II).

FIG. 34 shows a top, schematic view of a droplet generating portion of device 500. Droplet generation device 500 includes a channel network 56 having a sample input channel 68, a pair of first carrier input channels 70a and 70b intersecting the sample input channel to define a first channel junction 60 in a droplet generation region 58, and an output channel 72 extending downstream from first channel junction 60.

Sample arriving through sample input channel 68 intersects carrier fluid arriving through first carrier input channels 70a and 70b to form droplets at the droplet generation region that are then transported away through output channel 72, as in the embodiments shown, for example, in FIGS. 2, 10, 15, 16, and 30-32.

However, in contrast to these previous embodiments, channel network 56 in droplet generation device 500 further includes a second pair of carrier input channels 86a and 86b intersecting sample input channel 68 upstream from droplet generation region 58 to define a second channel junction 88. In other embodiments, the device may not have first carrier input channel 70b and/or second carrier input channel 86b.

Second channel junction 88 is upstream from first channel junction 60, and thus from the droplet generation region, by a sufficiently small distance D that carrier fluid entering the second channel junction from the second carrier input channels forms a barrier layer 85 (see FIG. 37) between at least one surface region of the sample input channel and sample fluid in a portion of the sample input channel extending between second channel junction 88 and first channel junction 60.

The channels of device 500 may have distinct depths. For example, first carrier input channels 70a and 70b may (or may not) be deeper than sample input channel 68, with the difference in depth creating a step 52. Alternatively, or in addition, sample input channel 68 may (or may not) be deeper than second carrier input channels 86a and 86b, with the difference in depth creating steps 502a and 502b.

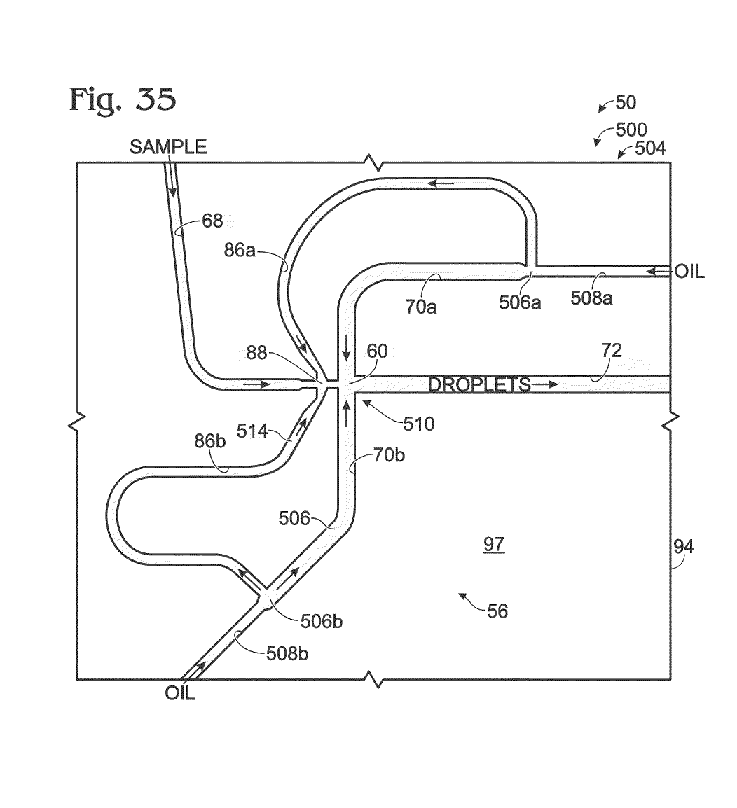

FIGS. 35-37 show various views of device 504, which is an embodiment of device 500 of FIG. 34.

FIG. 35 shows a top view of base 94 of device 504, taken in the absence of cap 96. Each corresponding pair of first and second carrier input channels, 70a and 86a, or 70b and 86b, may extend to junctions 60 and 88 from an upstream junction 506a or 506b, at which a channel 508a or 508b branches to form one of the corresponding pairs of carrier input channels. In other words, channel 508a supplies carrier fluid for the first and second carrier input channels 70a and 86a, and channel 508b supplies carrier fluid for first and second carrier input channels 70b and 86b.

Second carrier input channels 86a and 86b may intersect sample input channel 68 from two opposite lateral sides of the sample input channel, so that barrier layer 85 will be formed substantially symmetrically across the width of the sample input channel. Alternatively, supplemental carrier input channels can intersect the sample input channel in fewer or more than two locations, and/or from different directions, potentially resulting in an asymmetric barrier layer.

The distance D can be chosen to have any value sufficiently small or effective to create a carrier fluid barrier layer with desired properties to mitigate or prevent transient droplet generation effects. This distance may be correlated to another property of the channel network, such as the width of first carrier input channel 70a (and/or 70b ). For example, second channel junction 88 may be upstream from first channel junction 60 by a distance of less than four times the width of first carrier input channel 70a, a distance of less than twice times the width of first carrier input channel 70a, or a distance of less than the width of first carrier input channel 70a, among others.

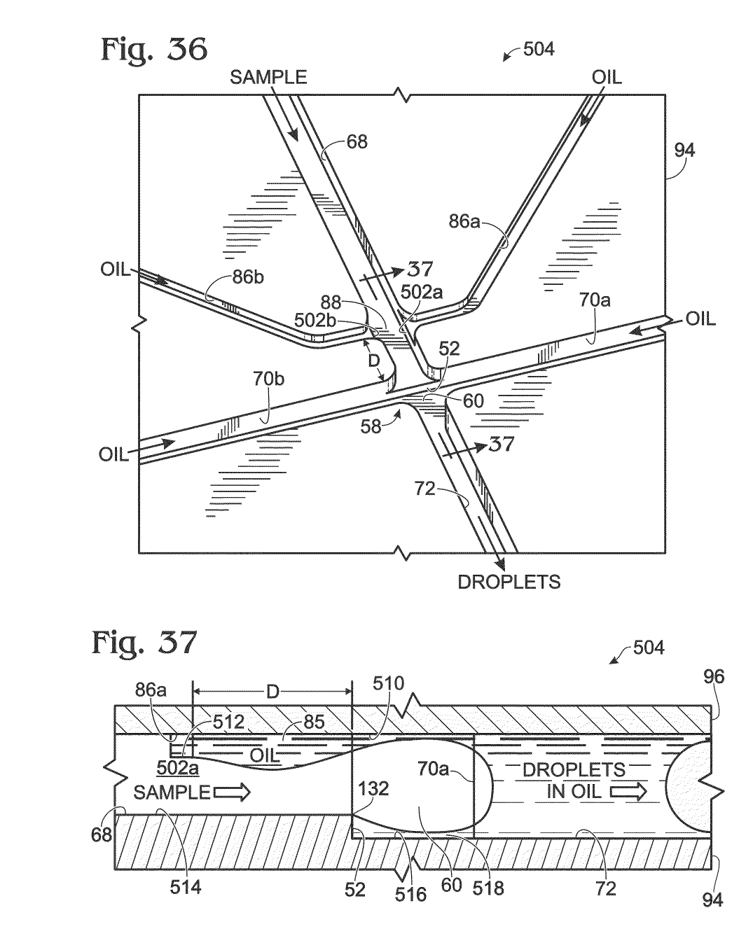

FIG. 36 shows an isometric view of base 94 of device 504, taken generally around a droplet generating portion of the device. The changes in channel depth generating steps 502a and 502b, and step 52, are shown at respective channel junctions 88 and 60.

FIG. 37 shows a cross-sectional view of device 504, taken around the droplet generating portion of the device in the presence of sample fluid and carrier fluid. Second carrier input channel 86a (and 86b ) is located adjacent cap 96, and thus barrier layer 85 is formed adjacent a ceiling region 510 of sample input channel 68 and junction region 60. A floor region 512 of each second carrier input channel is positioned closer to cap 96 than a floor region 514 of sample input channel 68 is spaced from the cap. Step 502a extends from an edge of floor region 512 of each carrier input channel 86a or 86b to floor region 514 of the sample input channel. Step 52 extends from floor region 514 of sample input channel 68 to a floor region 516 of carrier input channels 70a and 70b and/or junction region 60. Since sample fluid does not wet past edge 132 of step 52, a layer 518 of carrier fluid may separate the sample fluid (and/or a stream thereof) from floor region 516. Therefore, at least one auxiliary carrier input channel may be configured to create a barrier layer along the ceiling of a sample input channel, and a step may provide a convex corner or edge region configured to create a wetting boundary on an opposite side of the channel network, namely, the floor of the sample input channel. Thus, the auxiliary carrier input channel and the step may act together on opposite sides of the channel network to mitigate or eliminate transient droplet generation effects.

### Example 8

### Exemplary Boundary Layers Produced by Multiple Auxiliary Channels

This example describes exemplary droplet generation systems having boundary layers produced by multiple auxiliary channels; see FIG. 38.

FIG. 38 depicts a side view of a portion of an exemplary droplet generation device 600, including two separate auxiliary carrier fluid input channels configured to create wetting boundaries in the form of boundary layers along two different surfaces of a sample input channel, such as the top and bottom surface.

More specifically, device 600 includes a channel network 602 including a sample input channel 604, a first carrier input channel 606 intersecting the sample input channel to define a first channel junction 608 in a droplet generation region 610, an output channel 612 extending downstream from the first channel junction, second and third carrier input channels 614a, 614b intersecting the sample input channel to define a second channel junction 616 upstream from the droplet generation region. Accordingly, the second and third carrier input channels may be configured to generate a pair of barrier layers 618a, 618b along corresponding sides (in this case, the top and bottom) of the sample input channel. The second and third input channels may be directly above and below one another, as shown in FIG. 38, or they may be offset from one another, with the top channel closer than the bottom channel to the droplet generation region, or vice versa. The second and third input channels each may comprise pairs of channels intersecting from opposite sides of the sample channel, for example, as shown in FIG. 34. The remaining features of device 600 may be similar or identical to the features of device 500, and will not be described further.

### Example 9

### Methods of Producing Droplets Using a Barrier Layer

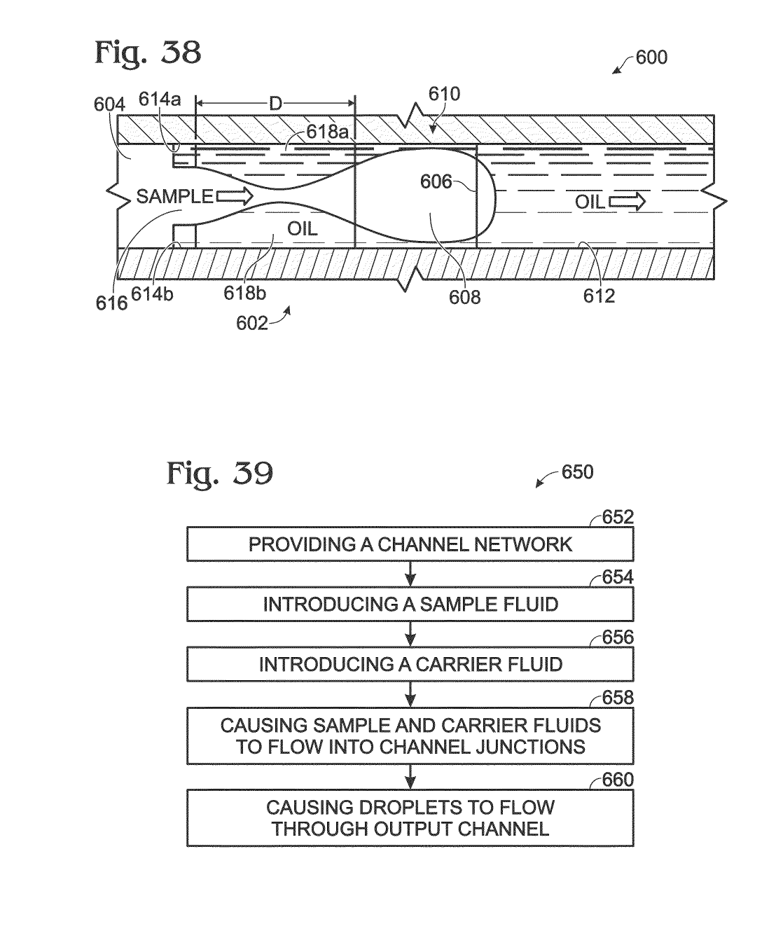

FIG. 39 is a flowchart depicting a method, generally indicated at 650, for producing droplets according to aspects of the present disclosure. The steps presented in FIG. 39 may be performed in any suitable order and combination.

At step 652, a channel network is provided, including a sample input channel, at least one first carrier input channel intersecting the sample input channel to define a first channel junction in a droplet generation region, an output channel extending downstream from the first channel junction, and at least one second carrier input channel intersecting the sample input channel to define a second channel junction upstream from the first channel junction.

At step 654, a sample fluid is introduced into the sample input channel, and at step 656, carrier fluid is introduced into the one or more first carrier input channels and into the one or more second carrier input channels.

At step 658, the sample fluid is caused to flow through the sample input channel and the carrier fluid is caused to flow through the first and second carrier input channels and into the first and second channel junctions, respectively, to form a barrier layer of carrier fluid between at least one surface of the sample input channel and the sample fluid in a region of the sample input channel extending between the second channel junction and the first channel junction, and to form droplets of sample fluid suspended within carrier fluid in the droplet formation region.

At step 660, the droplets are caused to flow away from the droplet formation region through the output channel. Additional steps may be performed in conjunction with method 650, for example, to prepare the sample fluid, to amplify any target molecules present in the generated droplets, and/or to analyze the droplets for the presence and concentration of target molecules. The steps of method 650 may be performed using the devices described above, which in some cases may include a convex corner or other similar feature to produce a wetting boundary based on geometrical features, in addition to a carrier fluid barrier layer formed by an auxiliary carrier input channel and/or a flow-modifying structure at least partially disposed in a carrier input channel.

The flow rate of carrier fluid into the second (upstream) channel junction, from the at least one second carrier input channel, can affect the size of droplets that are formed. For example, the flow rate of carrier fluid into the upstream channel junction can have an inverse affect on the size of droplets formed at the first (downstream) channel junction. Accordingly, increasing the flow rate of carrier fluid into the upstream channel junction can decrease droplet size, and decreasing the flow rate of carrier fluid into the upstream channel junction can increase droplet size. The droplet size thus can, in some cases, be selected and adjusted without changing the device geometry, and, optionally, without changing the flow rate of sample fluid or carrier fluid (from at least one downstream carrier input channel) into the downstream channel junction. Generally, the effect of flow rate on droplet size may be most pronounced when the upstream channel junction is relatively close to the downstream channel junction, such as spaced by a distance less than about four, three, or two channel widths (of the sample input channel).

In a method of forming droplets (and/or a method of fluid processing), a flow rate of carrier fluid into the upstream channel junction may be established and/or adjusted according to a desired droplet size to be achieved. In some cases, the relationship between the flow rate and droplet size produced may be predetermined, such as in a calibration process.

In another method of forming droplets, the size of droplets being formed may be measured, and the flow rate of carrier fluid into the upstream channel junction may be adjusted according the measured size of the droplets. In other words, the droplet generation system may utilize a feedback loop to dynamically control the droplet size based on a desired droplet size to be achieved.

In yet another method of forming droplets, a device may have a plurality of droplet generation regions, each having first and second channel junctions. A flow rate of carrier fluid into at least one upstream channel junction, for at least one of the droplet generation regions, may be adjusted to balance/equalize the size of droplets generated by the plurality of the droplet generation regions. For example, if a manufactured batch of copies the device is determined, by post-manufacture testing, to produce smaller droplets at a first droplet generation region relative to a second droplet generation region for each copy of the batch, a system that controls flow of carrier fluid into each upstream channel junction may be instructed to select and produce a different flow rate of carrier fluid into the upstream channel junction for the first droplet generation region relative to the second droplet generation region, to balance droplet sizes from the two droplet generation regions.

### Example 10

### Exemplary Droplet Generation with Flow-Modifying Structures

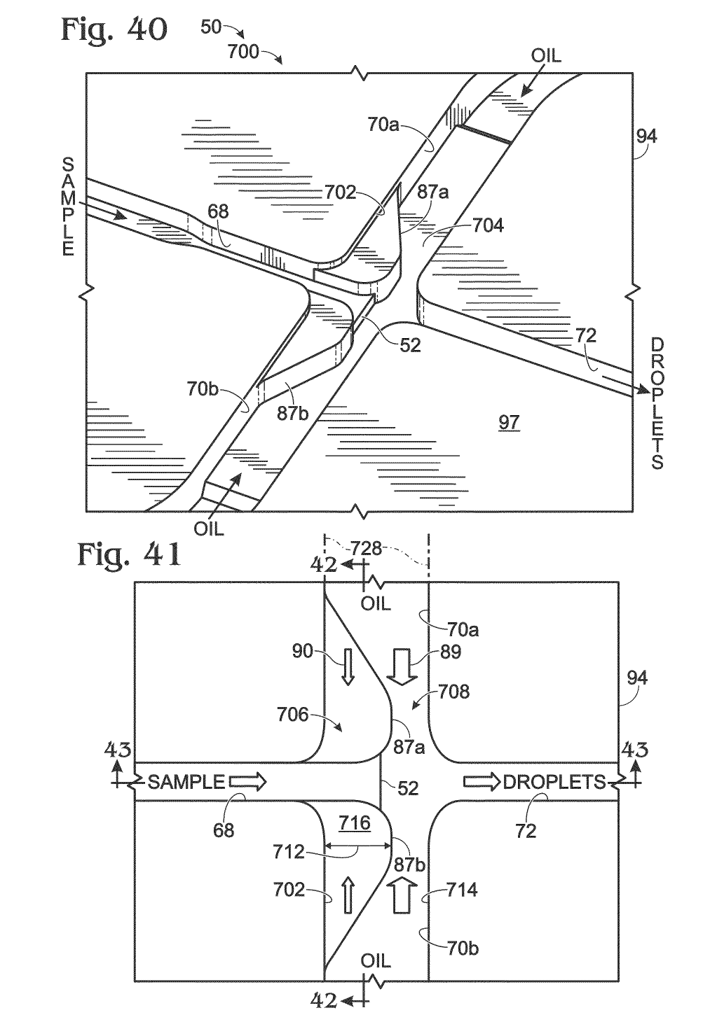

This example describes exemplary methods and apparatus for generating droplets with at least one flow-modifying structure formed in at least one carrier input channel; see FIGS. 40-48. The methods and apparatus disclosed in the example may be combined with or modified by any other methods and apparatus of the present disclosure.

The methods and apparatus may include a droplet generation cross that further reduces temporal variation in droplet size. Aspects of the disclosure above involve a “step” cross generator that can pin a sample-oil interface at a prescribed geometric location. However, in planar droplet generators the “top” film may have no surface features and thus can still exhibit transient behavior. The designs described in this section may force the droplet generator to stay in the “pre-transient” phase during an entire droplet production run, by constantly refreshing the oil layer along a region of the ceiling above the sample. During an initial transient that affects droplet generation, the sample is displacing oil that originally resided in the cross. Over time it fully displaces the oil and wets the surface. The droplet generators of this section may provide a very slow oil flow that constantly refreshes and maintains the barrier layer on the ceiling of the channel. This can be implemented as shown below.

FIG. 40 shows an exemplary droplet generation device 700, taken from generally above base 94 in the absence of cap 96. Device 700 may have a droplet-producing portion with a cross design formed by a sample input channel 68, a pair of carrier input channels 70a and 70b, and an emulsion output channel 72. A pair of flow-modifying structures 87a and 87b may be formed in carrier input channels 70a and 70b as respective projections extending into each channel from a lateral side wall region 702 and a bottom wall region 704 of the carrier input channel, to decrease the cross-sectional area of the channel. Lateral side wall region 702 may be on the sample input side of each carrier input channel. Flow-modifying structures 87a and 87b may be formed on respective opposite lateral sides of sample input channel 68, and may partially define an open portion of the sample input channel (see below).

In this device, the flow-modifying structure (e.g., an “oil weir”) located in the two carrier input channels may constrict carrier flow such that droplet generation does not occur in the “weired” section of the junction (i.e., between flow-modifying structures 87a and 87b ). This prevents the onset of droplet generation until a leading portion of the sample has traveled past the flow-modifying structures, but enables the formation of a lubrication layer adjacent cap 96. Downstream of flow-modifying structures 87a and 87b droplet generation begins, and a step may be present to pin the position of the sample along the floor.

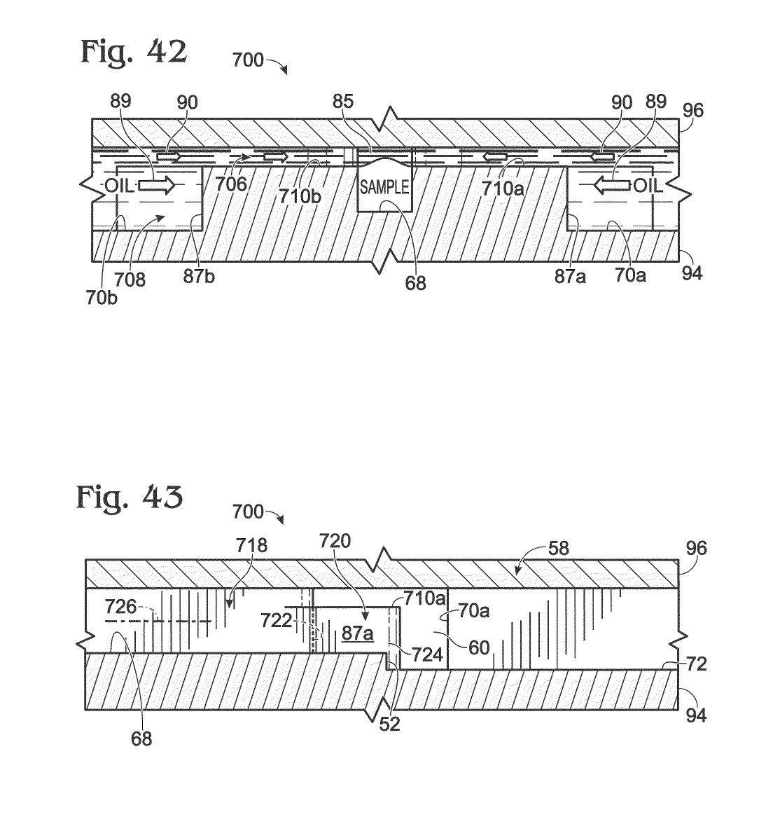

FIGS. 41 and 42 show how flow-modifying structures 87a and 87b may direct flow of carrier fluid. Each flow-modifying structure 87a and 87b may be configured to direct portions of carrier fluid to an overlying region 706 above each flow-modifying structure and to a lateral region 708 that is disposed laterally from the flow-modifying structure. More particularly, a barrier flow 90 is directed through overlying region 706 and to a position over the sample, between the sample (or sample stream) and cap 96, to form barrier layer 85. Also, a dividing flow 89 is directed, at least in part, through lateral region 708 and into contact with the sample to divide portions of the sample stream into droplets. Barrier flow 90 and dividing flow 89 may be in any suitable proportion. For example, the flow-modifying structure(s) may be configured such that the barrier flow is less than one-half, such as less than about 25% or 15%, among others, of the total flow of carrier fluid through the junction region.

The flow-modifying structure may have any suitable dimensional relationship to the carrier input channel in which the flow-modifying structure is formed. Each flow-modifying structure may be shorter than the height of the corresponding carrier input channel in which the flow-modifying structure is at least partially disposed, to form an opening 710a or 710b (interchangeably termed a gap) between the top of the flow-modifying structure and cap 96, thereby creating overlying region 706 (see FIG. 42). The height of flow-modifying structure 87a or 87b may, for example, be greater than one-half of the height of the corresponding carrier input channel, such as at least about 60% or 75% of the height, among others. The flow-modifying structure may have any suitable characteristic dimension or width 712 measured between opposing lateral side wall regions 702 and 714 of the carrier input channel (see FIG. 41). Width 712 may be at least about one-third or one-half of the corresponding width of the carrier input channel.

Flow-modifying structure 87 may have any suitable shape. The flow-modifying structure may form a shelf 716 extending from lateral side wall 702 of the carrier input channel. The shelf may have a uniform height, as shown, to form a plateau, or the shelf may taper in height, such as in a direction toward an adjacent portion of dividing flow 89 and/or lateral side wall region 714. The flow-modifying structure may have a uniform width or may taper, for example, in a direction opposite to the direction of carrier fluid flow, as shown.

FIG. 43 shows a longitudinal sectional view taken through sample input channel 68 and output channel 72 of device 700. Channel 68 may have a closed portion 718 and an open portion 720 extending from the closed portion to channel junction 60. Closed portion 718 is circumferentially bounded by base 94 and cap 96 and defines an end 722 through which portions of a sample stream flow out of the closed portion and into open portion 720. Open portion 720 has openings 710a and 710b that permit carrier fluid to contact portions of the sample stream before the portions have exited the sample input channel. More particularly, openings 710a and 710b provide communication of carrier input channels 70a, 70b with sample input channel 68, adjacent cap 96, upstream of a downstream terminus 724 of open portion 720.

Base 94 may define a step 52 within sample input channel 68, or at channel terminus 724 of the sample input channel 68, among others. Step 52 may be formed within closed portion 718 or open portion 720 of channel 68. For example, the step may be flush with, or offset from, end 722 of closed portion 718, in a direction parallel to a long axis 726 of the channel (and/or a flow path of the sample stream). The step may be formed by an increase in the depth of the channel network, such as when sample input channel 68 ends at channel junction 60. Step 52 may be flanked by flow-modifying structures 87a and 87b or may be flush with the structures, or offset from the flow-modifying structures in an upstream direction or a downstream direction with respect to sample flow. The step may be positioned intermediate a pair of parallel planes 728 (see FIG. 41). Planes 728 may be orthogonal to the plane defined by the channel network and represent the opposing lateral boundaries, such as the maximum channel width, adjacent channel junction 60 for carrier input channel 70a and/or 70b.

Device 700 or any of the related devices disclosed herein may be modified in any suitable manner. For example, the device may have a pair of carrier input channels 70a, 70b but only one flow-modifying structure 87 positioned on only lateral side of channel 68 and projecting into only one of the carrier input channels. As another example, the device may have only one carrier input channel 70 and only one flow-modifying structure 87.

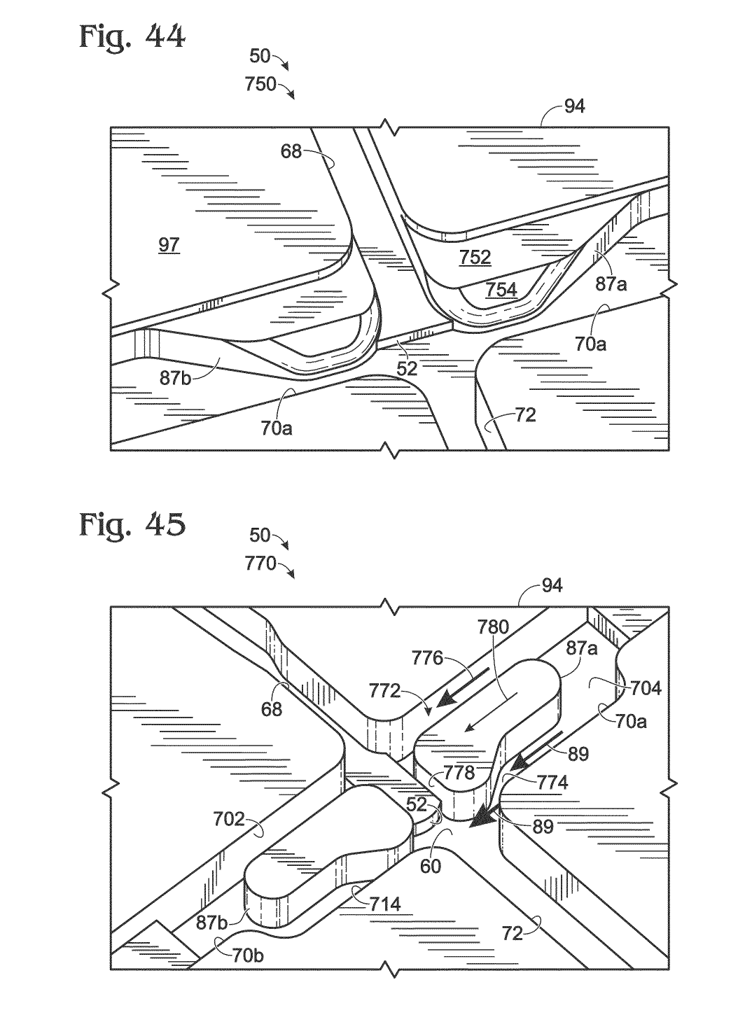

FIG. 44 shows another exemplary droplet generation device 750 having flow flow-modifying structures 87a and 87b formed at least predominantly in carrier input channels 70a and 70b. Device 750 is viewed in FIG. 45 from generally above base 94 and in the absence of cap 96. Here, the flow-modifying structures taper in the direction of sample flow. More particularly, each flow-modifying structure may have a plateau region 752 and a sloped region 754 extending from the plateau region. As a result, the depth of sample input channel 68 can decrease toward step 52, along an open portion of the channel, which may advantageously reduce the ability of the sample to wet the flow-modifying structures downstream of the step.

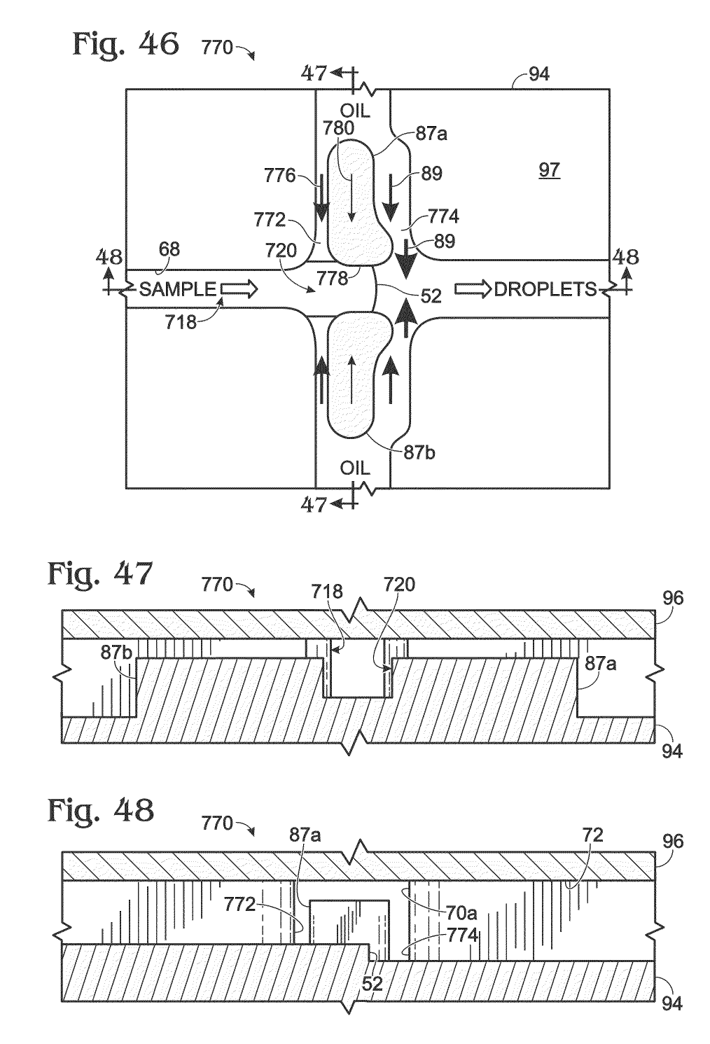

FIGS. 45-48 show various views of another exemplary droplet generation device 770 having flow-modifying structures 87a and 87b formed in carrier input channels 70a and 70b. (FIGS. 45 and 46 show the device in the absence of cap 96.) Flow-modifying structures 87a and 87b are formed as islands projecting toward cap 96 from a floor region 704 of base 94. Each flow-modifying structure may be spaced from both opposing lateral side wall regions 702 and 714 of a carrier input channel to define a pair of open sub-channels 772 and 774 that are not circumferentially bounded. Sub-channels 772 and 774 may be positioned respectively upstream and downstream relative to one another along a sample stream flowing through sample input channel 68. Each flow-modifying structure may direct portions of carrier fluid to form at least three flow regions, with relative flow velocities identified by different sizes of flow arrows.

Each flow-modifying structure may participate in formation of at least two barrier flows. Sub-channel 772 may direct a first barrier flow 776 to the sample stream traveling in channel 68, which may form a barrier layer of fluid adjacent cap 96 and a barrier layer on a lateral side of the sample stream adjacent a side wall region 778 of flow-modifying structure 87a (and flow-modifying structure 87b for the opposite sub-channel 772). The flow-modifying structure also may direct a second barrier flow 780 to the sample stream between the flow-modifying structure and cap 96, in a manner analogous to formation of barrier flow 90 by device 700 of FIG. 40.

Each barrier also may participate in formation of a dividing flow 89, generally as described above for device 700 of FIG. 40. Sub-channel 774 may narrow toward the junction region 60, such that the velocity of the velocity of the dividing flow increases near the junction region.

Accordingly, improved function can be provided by the island design of structure 87. The use of an island allows for three distinct velocity zones along the length of the Raleigh-Plateau instability region of the droplet breakup. A narrow and tall channel 772 provides for medium flow rates. This initial impingement on the sample stream can cause the sample stream to be pushed off cap 96 and float on a lubrication layer. Above the island, an overlaying region provides low velocity oil addition to keep the sample stream from re-wetting cap 96. In a third zone, a lower resistance upstream channel 774 allows more flow of carrier fluid through this section, and then is focused into a high velocity stream at the channel junction to cut the sample stream very precisely into droplets.

Sample input channel 68 may have a closed portion 718 and an open portion 720 (see FIGS. 46 and 47).

### Example 11

### Selected Embodiments I

This example presents selected embodiments of the present disclosure related to apparatus and methods for controlling droplet generation with at least one sample-positioning feature. The selected embodiments are presented as a series of indexed paragraphs.

A. A device for producing droplets, comprising a channel network including a sample input channel, a first carrier input channel intersecting the sample input channel to define a first channel junction in a droplet generation region, an output channel extending downstream from the first channel junction, and a second carrier input channel intersecting the sample input channel to define a second channel junction upstream from the droplet generation region; wherein the second channel junction is upstream from the first channel junction by a sufficiently small distance so that carrier fluid entering the second channel junction from the second carrier input channel forms a barrier layer between at least one surface of the sample input channel and sample fluid in a region of the sample input channel extending between the second channel junction and the first channel junction.

A1. The device of paragraph A, wherein the second carrier input channel intersects the sample input channel from exactly one side of the sample input channel.

A2. The device of paragraph A1, wherein a convex corner is disposed on a side of the sample input channel substantially opposite the side from which the second carrier input channel intersects the sample input channel.

A3. The device of paragraph A2, wherein the convex corner is configured to serve as a wetting boundary for an aqueous sample carried to the first channel junction by the sample input channel.

A4. The device of paragraph A, wherein the second carrier input channel intersects the sample input channel from two sides of the sample input channel.

A5. The device of paragraph A, wherein the channel network is substantially planar.

B. A device for producing droplets, comprising a channel network including a sample input channel, a first carrier input channel intersecting the sample input channel to define a first channel junction in a droplet generation region, an output channel extending downstream from the first channel junction, and a second carrier input channel intersecting the sample input channel to define a second channel junction upstream from the droplet generation region; wherein the first carrier input channel has a width, and the second channel junction is upstream from the first channel junction by a distance of less than four times the width of the first carrier input channel.

B1. The device of paragraph B, wherein the second channel junction is upstream from the first channel junction by a distance of less than twice the width of the first carrier input channel.

B2. The device of paragraph B, wherein the second channel junction is upstream from the first channel junction by a distance of less than the width of the first carrier input channel.

B3. The device of paragraph B, wherein the second carrier input channel intersects the sample input channel from exactly one side of the sample input channel.

B4. The device of paragraph B3, wherein a convex corner is disposed on a side of the sample input channel substantially opposite the side from which the second carrier input channel intersects the sample input channel.

B5. The device of paragraph B4, wherein the convex corner is configured to serve as a wetting boundary for an aqueous sample carried to the first channel junction by the sample input channel.

B6. The device of paragraph B, wherein the second carrier input channel intersects the sample input channel from two sides of the sample input channel.

B7. The device of paragraph B, wherein the channel network is substantially planar.

C. A method for producing droplets, comprising (A) providing a channel network including a sample input channel, a first carrier input channel intersecting the sample input channel to define a first channel junction in a droplet generation region, an output channel extending downstream from the first channel junction, and a second carrier input channel intersecting the sample input channel to define a second channel junction upstream from the first channel junction; (B) introducing a sample fluid into the sample input channel; (C) introducing a carrier fluid into the first carrier input channel and into the second carrier input channel; (D) causing the sample fluid to flow through the sample input channel and the carrier fluid to flow through the first and second carrier input channels and into the first and second channel junctions respectively, to form a barrier layer of carrier fluid between at least one surface of the sample input channel and the sample fluid in a region of the sample input channel extending between the second channel junction and the first channel junction, and to form droplets of sample fluid suspended within carrier fluid in the droplet formation region; and (E) causing the droplets to flow away from the droplet formation region through the output channel.

C1. The method of paragraph C, wherein the first carrier input channel has a width, and the second channel junction is upstream from the first channel junction by a distance of less than twice the width of the first carrier input channel.

C2. The method of paragraph C, wherein the first carrier input channel has a width, and the second channel junction is upstream from the first channel junction by a distance of less than the width of the first carrier input channel.

C3. The method of paragraph C, wherein the second carrier input channel intersects the sample input channel from exactly one side of the sample input channel.

C4. The method of paragraph C3, wherein a convex corner is disposed on a side of the sample input channel substantially opposite the side from which the second carrier input channel intersects the sample input channel.

C5. The method of paragraph C4, wherein the convex corner is configured to serve as a wetting boundary for an aqueous sample carried to the first channel junction by the sample input channel.

C6. The method of paragraph C, wherein the second carrier input channel intersects the sample input channel from two sides of the sample input channel.

C7. The method of paragraph C, wherein the channel network is substantially planar.

D. The device of paragraph A or B, wherein the sample contains nucleic acid.

D1. The device of paragraph A or B, wherein the sample is capable of amplifying a nucleic acid target, if present, in the sample.

D2. The device of paragraph A or B, wherein the sample contains a polymer at a concentration of at least about 0.1 ng/μL and with an average molecular weight of at least about 675 kDa.

D3. The device of paragraph D2, wherein the polymer is nucleic acid.

D4. The device of paragraph A or B, further comprising a sample input reservoir in fluid communication with the sample input channel and a carrier input reservoir in fluid communication with the first and second carrier input channels.

D5. The device of paragraph D4, wherein each reservoir is a well that is loadable and/or unloadable from above the well.

D6. The device of paragraph A or B, further comprising a monolithic member that forms the ceiling of the channel network.

D7. The device of paragraph D6, wherein the monolithic member that forms the ceiling is a single injection-molded piece. D8. The device of any of paragraphs A or B, further comprising a monolithic member that forms the floor of the channel network.

D9. The device of paragraph D8, wherein the monolithic member that forms the floor is a sheet.

D10. The device of paragraph D9, wherein the sheet is a film having a thickness of less than about one millimeter.

E1. A device for producing droplets, comprising: a channel network including a sample input channel and a carrier input channel each extending to a channel junction in a droplet generation region, and an output channel extending from the channel junction, wherein at least one wall of the channel network has an abrupt change in contour to form a convex corner at the channel junction, immediately upstream of the channel junction in the sample input channel, or both.

E2. The device of paragraph E1, wherein the channel network is planar.

E3. The device of paragraph E1 or E2, wherein a convex corner is defined by a ceiling of the channel network, a floor of the channel network, or both the ceiling and the floor.

E4. The device of any of paragraphs E1 to E3, wherein a convex corner is defined by a lateral side wall of the sample input channel.

E5. The device of any of paragraphs E1 to E4, wherein the lateral side wall of the sample input channel defines a series of convex corners arranged along the sample input channel immediately upstream of the channel junction.

E6. The device of any of paragraphs E1 to E5, wherein the convex corner is configured to serve as a wetting boundary for an aqueous sample carried to the channel junction by the sample input channel.

E7. The device of any of paragraphs E1 to E6, wherein a wall of the channel network defines a series of convex corners each having a sharp edge produced by an abrupt change in contour of the wall at the channel junction, immediately upstream of the channel junction in the sample input channel, or both.

E8. The device of any of paragraphs E1 to E7, wherein one or more walls of the channel network are injection molded.

E9. A device for producing droplets, comprising: a channel network including a sample input channel and a carrier input channel each extending to a channel junction in a droplet generation region, and an output channel extending from the channel junction, wherein the channel network defines a plane and has a floor and a ceiling arranged parallel to the plane, and wherein an elevation of the floor decreases abruptly and/or an elevation of the ceiling increases abruptly at the channel junction, immediately upstream of the channel junction in the sample input channel, or both.

E10. A device for producing droplets, comprising: a planar channel network including a sample input channel and a carrier input channel each extending to a channel junction in a droplet generation region, and an output channel extending from the channel junction, wherein a height of the channel network increases abruptly at the channel junction, immediately upstream of the channel junction in the sample input channel, or both.

E11. A device for producing droplets, comprising: a sample input channel and a carrier input channel each extending to a channel junction in a droplet generation region, the input channels being substantially coplanar with each other to define a plane, and an output channel extending from the channel junction, wherein an edge oriented transverse to the sample input channel and substantially parallel to the plane is formed by a convex corner at the channel junction, immediately upstream of the channel junction in the sample input channel, or both, wherein the convex corner is optionally formed by a step, and wherein the step is optionally defined by a ceiling of the channel junction and/or the sample input channel.

E12. A device for producing droplets, comprising: a sample input channel and a carrier input channel each extending to a channel junction in a droplet generation region, and an output channel extending from the channel junction, wherein a wetting boundary is formed at the channel junction, immediately upstream of the channel junction in the sample input channel, or both, and wherein the wetting boundary is optionally a geometrical wetting boundary.

E13. The device of any of paragraphs E9 to E12, wherein the input channels and the output channel are substantially coplanar with one another.

E14. The device of any of paragraphs E9 to E13, wherein the channel network includes a pair of carrier input channels each extending to the channel junction.

E15. The device of any of paragraphs E9 to E14, wherein the sample input channel defines a long axis extending through the channel junction, and wherein an elevation of the floor or the ceiling increases abruptly and decreases abruptly at a pair of positions along the axis such that the floor or ceiling defines a recess or a projection at the channel junction and/or immediately upstream of the channel junction in the sample input channel.

E16. The device of paragraph E15, wherein the elevation changes at the pair of positions to define a recess that is a notch or a groove.

E17. The device of paragraph E15, wherein the recess or projection is one groove or ridge of a series of grooves or ridges arranged laterally to one another.

E18. The device of paragraph E17, wherein the series of grooves or ridges only partially overlap the channel junction.

E19. The device of paragraph E15, wherein the elevation changes at the pair of positions to define a projection that is generally triangular in profile and/or that steps up and steps down.

E20. The device of paragraph E15, wherein the elevation changes at the pair positions to define a projection that is an elongate ridge.

E21. The device of any of paragraphs E9 to E20, wherein the sample input channel contains a sample, wherein the carrier input channel contains a carrier fluid, and wherein the output channel contains droplets including the sample and disposed in the carrier fluid.

E22. The device of paragraph E21, wherein the sample contains nucleic acid.

E23. The device of paragraph E21 or E22, wherein the sample is capable of amplifying a nucleic acid target, if present, in the sample.

E24. The device of any of paragraphs E21 to E23, wherein the sample contains a polymer at a concentration of at least about 0.1 ng/μL and with an average molecular weight of at least about 675 kDa.

E25. The device of paragraph E24, wherein the polymer is nucleic acid.

E26. The device of any of paragraphs E9 to E25, further comprising a sample input reservoir in fluid communication with the sample input channel and a carrier input reservoir in fluid communication with the carrier input channel.

E27. The device of paragraph E26, wherein each reservoir is a well that is loadable and/or unloadable from above the well.

E28. The device of any of paragraphs E9 to E27, further comprising a monolithic member that forms the ceiling of the channel network.

E29. The device of paragraph E28, wherein the monolithic member that forms the ceiling is a single injection-molded piece.

E30. The device of any of paragraphs E9 to E29, further comprising a monolithic member that forms the floor of the channel network.

E31. The device of paragraph E30, wherein the monolithic member that forms the floor is a sheet.

E32. The device of paragraph E31, wherein the sheet is a film having a thickness of less than about one millimeter.

E33. A method of producing droplets with the device of any of paragraphs 1 to

32, comprising: (A) flowing a sample and carrier fluid along the sample input channel and the carrier input channel to the channel junction; (B) forming droplets including the sample and disposed in the carrier fluid; and (C) flowing the droplets in carrier fluid in the output channel away from the channel junction.

E34. The method of paragraph E33, wherein non-zero normal stresses are imposed on the sample during droplet formation.

### Example 12

### Selected Embodiments II

This example presents further selected embodiments of the present disclosure related to apparatus and methods for controlling droplet generation with at least one sample-positioning feature. The selected embodiments are presented as a series of indexed paragraphs.

A1. A method of forming droplets of an emulsion, the method comprising: (a) creating a sample stream; (b) dividing portions of the sample stream into droplets disposed in carrier fluid after each portion exits a sample input channel; and (c) directing carrier fluid into contact with the portions of the sample stream at a position upstream from where the portions exit the sample input channel.

A2. The method of paragraph A1, wherein the step of dividing and the step of directing are each performed at least in part with carrier fluid supplied by a same carrier input channel that extends to a channel junction at which the sample input channel joins the carrier input channel.

A3. The method of paragraph A1, wherein the step of directing carrier fluid is performed at least in part by at least one flow-modifying structure projecting into a carrier input channel.

A4. The method of paragraph A1, wherein the sample input channel is formed by a base member defining at least one recess and a cap member attached to the base member and covering the at least one recess, and wherein the step of directing carrier fluid includes a step of directing a barrier flow of the carrier fluid to a first side of the sample stream that is closer to the cap member than the base member.

A5. The method of paragraph A4, wherein the cap member forms a floor or a ceiling of the sample input channel and not lateral side wall regions of the sample input channel.

A6. The method of paragraph A4, wherein the step of directing carrier fluid includes a step of directing a portion of the carrier fluid such that the portion of carrier fluid forms a barrier layer disposed between a region of the sample stream and a region of the cap member.

B1. A method of forming droplets of an emulsion, the method comprising: (a) creating a sample stream having a first side and a second side that are opposite and spaced from each other in a direction transverse to a plane defined by a channel network containing the sample stream; (b) dividing the sample stream into droplets with a first portion of carrier fluid; and (c) directing a second portion of carrier fluid selectively to the first side relative to the second side of the sample stream at a position upstream from where the sample stream is divided into droplets.

B2. The method of paragraph B1, wherein the channel network is formed at least in part by a base member defining one or more recesses and a cap member attached to the base member and covering the one or more recesses, wherein the first side of the sample stream is adjacent the cap member and the second side of the sample stream is adjacent the base member, and wherein the step of directing a second portion of carrier fluid includes a step of directing a barrier flow of carrier fluid selectively to the first side relative to the second side of the sample stream.

B3. The method of paragraph B2, wherein the cap member forms a floor or a ceiling of the channel network and not any lateral side walls of the channel network.

B4. The method of paragraph B2, wherein the step of directing a barrier flow of carrier fluid includes a step of directing a second portion of carrier fluid such that the second portion forms a barrier layer disposed between a region of the sample stream and a region of the cap member.

B5. The method of paragraph B1, wherein the first portion of carrier fluid contacts the sample stream at a channel junction, and wherein the first portion of carrier fluid flows in at least a pair of channels to the channel junction.

B6. The method of paragraph B1, wherein the first portion of carrier fluid intersects the sample stream at a channel junction of the channel network, and wherein the first portion is carried by a single channel to the channel junction.

B7. The method of paragraph B1, wherein the first portion of carrier fluid contacts the sample stream at a channel junction, wherein the first portion forms a dividing flow of carrier fluid and the second portion forms a barrier flow of carrier fluid, and wherein at least part of the dividing flow and at least part of the barrier flow travel in a same channel to the channel junction.

B8. The method of paragraph B7, wherein at least part of the dividing flow and at least part of the barrier flow occur in contiguous regions of a same channel.

B9. The method of paragraph B1, wherein the first portion forms a dividing flow of carrier fluid and the second portion forms a barrier flow of carrier fluid, and wherein the dividing flow of carrier fluid occurs in a region of the channel network that is deeper on average than a region of the channel network in which the barrier flow occurs.

B10. The method of paragraph B1, wherein the first portion forms a dividing flow of the carrier fluid and the second portion forms a barrier flow of the carrier fluid, wherein the barrier flow includes flow portions that approach the sample stream from at least generally opposite directions.

B11. The method of paragraph B1, wherein the sample stream is carried by a sample input channel, wherein the first portion of carrier fluid flows in one or more first channels extending to a first channel junction at which the sample stream is divided, and wherein the second portion of carrier fluid flows in one or more second channels distinct from the one or more first channels and intersecting the sample input channel upstream of the first channel junction at a second channel junction.

B12. The method of paragraph B11, wherein a third channel branches to form at least one of the first channels and at least one of the second channels, and wherein the third channel directs carrier fluid to the at least one first channel and the at least one second channel.

B13. The method of paragraph B12, wherein the first portion of carrier fluid contacts the sample stream at a first channel junction, and wherein the second portion of carrier fluid contacts the sample stream at a distinct second channel junction.

B14. The method of paragraph B1, wherein the sample stream contacts the first portion of carrier fluid at a channel junction of the channel network, and wherein the second side of the sample stream contacts an edge of a step member defined by the channel network near or at the channel junction.

B15. The method of paragraph B1, wherein the step of directing a second portion of carrier fluid is performed at least in part by at least one flow-modifying structure projecting into at least one carrier input channel that extends to the sample stream.

C1. A method of forming droplets of an emulsion, the method comprising: (a) creating a sample stream flowing out of a channel, the channel being formed at least in part by a recess defined by a base member and covered by a cap member attached to the base member; (b) forming a dividing flow of carrier fluid that divides the sample stream into droplets; and (c) directing a barrier flow of the carrier fluid to a position between the sample stream and the cap member upstream of where the sample stream contacts the dividing flow.

C2. The method of paragraph C1, wherein the sample stream flows out of a sample input channel, and wherein the step of directing a barrier flow includes a step of directing the barrier flow at least in part with at least one flow-modifying structure projecting into a carrier input channel that intersects the sample input channel.

D1. A method of forming droplets of an emulsion, the method comprising: (a) creating a sample stream flowing out of a first channel, the first channel being formed at least in part by a recess defined by a base member and covered by a cap member attached to the base member; and (b) causing a first portion of carrier fluid to flow in one or more second channels to the sample stream to divide the sample stream into droplets, at least one of the second channels having at least one flow-modifying structure projecting into the at least one second channel and directing a second portion of the carrier fluid into contact with the sample stream adjacent the cap member.

E1. A method of forming droplets of an emulsion, the method comprising: (a) creating a sample stream flowing out of a first channel, the first channel being formed at least in part by a recess defined by a base member and covered by a cap member attached to the base member, the sample stream having a first side opposite a second side, the cap member being closer to the first side than the second side; and (b) causing a first portion of carrier fluid to flow in one or more second channels to the sample stream to divide the sample stream into droplets, at least one of the second channels having a flow-modifying structure projecting into the at least one second channel and directing a second portion of the carrier fluid selectively to the first side relative to the second side of the sample stream.

F1. A method of forming an emulsion, the method comprising: (a) creating a sample stream flowing in a circumferentially bounded portion of a sample input channel along a flow axis and out an end defined by the bounded portion near or at a channel junction of a channel network; (b) contacting an edge region of a step member with the sample stream, the edge region being offset from the end of the bounded portion in a direction parallel to the flow axis, the step member being formed by an increase in depth of a region of the channel network with the depth increasing in a downstream direction; and (c) dividing the sample stream into droplets with carrier fluid flowing in one or more second channels to the channel junction.

F2. The method of paragraph F1, wherein the step member is defined by the bounded portion of the sample input channel.

F3. The method of paragraph F1, wherein the step member is defined outside the bounded portion of the sample input channel.

F4. The method of paragraph F3, wherein the step member is defined downstream of the end of the bounded region.

F5. The method of paragraph F1, wherein an open portion of the sample input channel extends downstream from the bounded portion to a terminus of the open portion, and wherein the step member is formed at or near the terminus of the open portion.

F6. The method of paragraph F5, wherein the open portion defines a pair of lateral openings disposed across the sample input channel from each other.

G1. A device for forming an emulsion, comprising: (a) a sample input channel having a circumferentially bounded portion defining an end; (b) at least one carrier input channel intersecting the sample input channel to form a channel junction and configured to hold carrier fluid that divides portions of a sample stream from the sample input channel into droplets in the channel junction after the portions of the sample stream have left the sample input channel via the end; and (c) a step member configured to extend away from the sample stream and having an edge region offset in a direction parallel to the sample input channel from the end of the bounded portion of the sample input channel, the edge region being configured to be contacted by a portion of the sample stream before the portion of the sample stream is divided into droplets by the carrier fluid.

H1. A device for forming droplets of an emulsion, comprising: (a) a channel network including a sample input channel having a circumferentially bounded portion defining an end and configured to direct a sample stream into a channel junction, at least one carrier input channel intersecting the sample input channel at the channel junction and configured to hold carrier fluid that divides the sample stream into droplets, and a step member at which a depth of a region the channel network increases and having an edge region offset from the end of the circumferentially bounded portion of the sample input channel, the edge region being positioned to be contacted by a portion of the sample stream near or at the channel junction before the portion of the sample stream is divided into droplets.

I1. A device for forming droplets of an emulsion, comprising: (a) a channel network defining a channel plane and including a sample input channel configured to direct a sample stream into a channel junction, at least one carrier input channel intersecting the sample input channel at the channel junction and configured to hold carrier fluid that divides the sample stream into droplets, the at least one carrier input channel having opposing lateral side wall regions defining a pair of parallel planes arranged orthogonal to the channel plane and spaced from each other by a maximum width of the at least one carrier input channel near the channel junction, and a step member at which a depth of the channel network increases, the step member having an edge region positioned intermediate the pair of planes on a flow path of the sample stream.

J1. A device for forming droplets of an emulsion, comprising: (a) a base member defining one or more recesses; (b) a cap member attached to the base member and covering the one or more recesses such that the base and cap members collectively form a channel network including a sample input channel having a first wall region formed by the cap member and a second wall region opposite the first wall region and formed by the base member, the sample input channel being configured to direct a sample stream to a channel junction of the channel network, and at least one carrier input channel configured to direct a first portion of carrier fluid into contact with the sample stream at the channel junction to divide the sample stream into droplets, and to direct another portion of the carrier fluid selectively to the first wall region relative to the second wall region, upstream of where the sample stream contacts the first portion of carrier fluid.

K1. A device for forming droplets of an emulsion, comprising: (a) a base member; (b) a cap member attached to the base member; (c) a sample input channel having a first wall region formed by the cap member and a second wall region opposite the first wall region and formed by the base member, the sample input channel being configured to direct a sample stream to a channel junction; and (d) at least one carrier input channel defined collectively by the base member and the cap member and configured to direct a dividing flow of carrier fluid into contact with the sample stream at the channel junction to divide the sample stream into droplets, and to direct a barrier flow of carrier fluid selectively to the first wall region relative to the second wall region, upstream of where the sample stream is contacted with the dividing flow.

L1. A method of forming droplets of an emulsion, the method comprising: (a) selecting a desired droplet size and a flow rate corresponding to the desired droplet size; (b) creating a sample stream; (c) dividing the sample stream into droplets with carrier fluid flowing into contact with the sample stream at a first channel junction; and (d) directing carrier fluid into contact with the sample stream at a second channel junction upstream from the first channel junction and at the flow rate selected, such that droplets of the desired size are produced by the step of dividing.

L2. The method of paragraph L1, wherein the step of directing is performed at a pair of different flow rates to produce droplets of different size.

M1. A method of forming droplets of an emulsion, the method comprising: (a) creating a sample stream; (b) dividing the sample stream into droplets with carrier fluid flowing into contact with the sample stream at a first channel junction; (c) measuring a size of the droplets; and (d) adjusting a flow rate of carrier fluid flowing into contact with the sample stream at a second channel junction upstream from the first channel junction based on the size measured, to change a size of droplets produced.

M2. The method of paragraph M1, wherein the step adjusting includes a step of increasing the flow rate such that a size of the droplets is decreased.

M3. The method of paragraph M1, wherein the step adjusting includes a step of decreasing the flow rate such that a size of the droplets is increased.

M4. The method of paragraph M1, wherein the step of adjusting is based on a desired droplet size to be achieved.

N1. A method of processing fluid, the method comprising performing an assay on droplets formed by any method of Example 11 or Example 12.

N2. The method of paragraph N1, wherein the step of performing an assay includes a step of collecting data from the droplets, and wherein the data is related to a presence, concentration, and/or activity of an analyte in the droplets.

N3. The method of paragraph N2, further comprising a step of processing the data to determine a characteristic of the analyte.

N4. The method of paragraph N1, wherein the step of performing an assay includes a step of detecting light emitted from the droplets.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure. Further, ordinal indicators, such as first, second, or third, for identified elements are used to distinguish between the elements, and do not indicate a particular position or order of such elements, unless otherwise specifically stated.

We claim:

1. A method of forming droplets of an emulsion, the method comprising:
creating a sample stream;
dividing portions of the sample stream into droplets disposed in carrier fluid after each portion exits a sample input channel; and
directing carrier fluid into contact with the portions of the sample stream at a position upstream from where the portions exit the sample input channel.

2. The method of claim 1, wherein the step of dividing and the step of directing are each performed at least in part with carrier fluid supplied by a same carrier input channel that extends to a channel junction at which the sample input channel joins the carrier input channel.

3. The method of claim 1, wherein the sample stream flows in a sample input channel, and wherein the step of directing carrier fluid is performed at least in part by at least one flow-modifying structure projecting into at least one carrier input channel that intersects the sample input channel.

4. The method of claim 1, wherein the sample input channel is formed by a base member defining at least one recess and a cap member attached to the base member and covering the at least one recess, and wherein the step of directing carrier fluid includes a step of directing a barrier flow of the carrier fluid to a first side of the sample stream that is closer to the cap member than the base member.

5. The method of claim 4, wherein the cap member forms a floor or a ceiling of the sample input channel and not lateral side wall regions of the sample input channel.

6. The method of claim 4, wherein the step of directing carrier fluid includes a step of directing a portion of the carrier fluid such that the portion of carrier fluid forms a barrier layer disposed between a region of the sample stream and a region of the cap member.

7. A method of forming droplets of an emulsion, the method comprising:
creating a sample stream having a first side and a second side that are opposite and spaced from each other in a direction transverse to a plane defined by a channel network containing the sample stream;
dividing the sample stream into droplets with a first portion of carrier fluid; and
directing a second portion of carrier fluid selectively to the first side relative to the second side of the sample stream at a position upstream from where the sample stream is divided into droplets.

8. The method of claim 7, wherein the channel network is formed at least in part by a base member defining one or more recesses and a cap member attached to the base member and covering the one or more recesses, wherein the first side of the sample stream is adjacent the cap member and the second side of the sample stream is adjacent the base member, and wherein the step of directing a second portion of carrier fluid includes a step of directing a barrier flow of carrier fluid selectively to the first side relative to the second side of the sample stream.

9. The method of claim 8, wherein the step of directing a barrier flow of carrier fluid includes a step of directing a second portion of carrier fluid such that the second portion forms a barrier layer disposed between a region of the sample stream and a region of the cap member.

10. The method of claim 7, wherein the first portion of carrier fluid contacts the sample stream at a channel junction, and wherein the first portion of carrier fluid flows in at least a pair of channels to the channel junction.

11. The method of claim 7, wherein the first portion of carrier fluid contacts the sample stream at a channel junction, wherein the first portion forms a dividing flow of carrier fluid and the second portion forms a barrier flow of carrier fluid, and wherein at least part of the dividing flow and at least part of the barrier flow travel in a same channel to the channel junction.

12. The method of claim 7, wherein the first portion forms a dividing flow of carrier fluid and the second portion forms a barrier flow of carrier fluid, and wherein the dividing flow of carrier fluid occurs in a region of the channel network that is deeper on average than a region of the channel network in which the barrier flow occurs.

13. The method of claim 7, wherein the first portion of carrier fluid contacts the sample stream at a first channel junction, and wherein the second portion of carrier fluid contacts the sample stream at a distinct second channel junction.

14. The method of claim 7, wherein the sample stream contacts the first portion of carrier fluid at a channel junction of the channel network, and wherein the second side of the sample stream contacts an edge of a step member defined by the channel network near or at the channel junction.

15. The method of claim 7, wherein the sample stream flows in a sample input channel, and wherein the step of directing a second portion of carrier fluid is performed at least in part by at least one flow-modifying structure projecting into at least one carrier input channel that intersects the sample input channel.

16. A method of forming droplets of an emulsion, the method comprising:
creating a sample stream flowing in a circumferentially bounded portion of a sample input channel along a flow axis and out an end defined by the bounded portion near or at a channel junction of a channel network;
contacting an edge region of a step member with the sample stream, the edge region being offset from the end of the bounded portion in a direction parallel to the flow axis, the step member being formed by an increase in depth of a region of the channel network with the depth increasing in a downstream direction; and
dividing the sample stream into droplets with carrier fluid flowing in one or more second channels to the channel junction.

17. The method of claim 16, wherein the step member is defined by the bounded portion of the sample input channel.

18. The method of claim 17, wherein the step member is defined downstream of the end of the bounded region.

19. The method of claim 16, wherein an open portion of the sample input channel extends downstream from the bounded portion to a terminus of the open portion, and wherein the step member is formed at or near the terminus of the open portion.

20. The method of claim 19, wherein the open portion defines a pair of lateral openings disposed across the sample input channel from each other.
